(19) United States
(12) Patent Application Publication
(10) Pub. No.: US 2017/0017618 A1
(43) Pub. Date: Jan. 19, 2017

(54) UNIFIED PUBLISHING PLATFORM

(71) Applicant: GTxcel, Southborough, MA (US)

(72) Inventors: Bryan Dunn, Northborough, MA (US); Andrew Yip, Carlisle, MA (US); Petra McLure, Mildoes, NH (US)

(21) Appl. No.: 14/799,428

(22) Filed: Jul. 14, 2015

(51) Int. Cl. G06F 17/22; G06F 17/24

(52) U.S. Cl. CPC G06F 17/227; G06F 17/2247; G06F 17/248

(57) ABSTRACT

A unified publishing platform (UPP) system is disclosed that may process electronic content to identify content data irrespective of the format of the electronic content. Content data may be separated from formatting to generate electronic content with different formats. The content data may be transformed to a format configured for display by one or more destinations. The UPP system may generate electronic content having a format using a template (e.g., a content workflow) selected by a user for displaying content. One or more attributes associated with the content data may be used to identify content data for placement in a layout using a template. The electronic content may be parsed to identify semantic data that identifies content data in the electronic content. The semantic data may be associated with one or more attributes. The attribute(s) may identify one or more content items in content data.

### BACKGROUND

The present disclosure relates generally to publishing of electronic content. In particular, the present disclosure relates to techniques for transforming electronic content for publishing at different types of destinations.

With the proliferation of use of electronic devices (e.g., mobile devices and tablet computing devices) and the growth of digital media, content producers and publishers are increasingly shifting their production from traditional print publishing to electronic media publishing. The shift to electronic media distribution has led to many technological advances related to production and processing of electronic content.

Advances in the field of electronic content publishing have led to the development of template-based approaches for producing electronic content. In particular, U.S. published patent application no. 2012/0278704 (“TEMPLATE-BASED PAGE LAYOUT FOR WEB CONTENT”) describes techniques for performing a page layout for web content based on templates. U.S. published patent application no. 2013/0036196 (“METHOD AND SYSTEM FOR PUBLISHING TEMPLATE-BASED CONTENT”) describes techniques for publishing content on a specific type of mobile device. Such techniques may rely on the format of content as received from a source to determine an output layout. In applying such techniques, publishers may be restricted in their choices for choosing a workflow suitable for the type of content being published. Publishers may be further limited in the ways in which content may be presented for display at various different outputs because display of the content using a template may be dependent on a format of the content received from a source. Because of these challenges, additional scripts may have to be developed to adapt content for different outputs including social media applications, web applications, and content publishing Websites. In some instances, publishers may be restricted in their ability to develop or choose a content layout because content have a format that hinders restructuring of the content data within the content.

Various publishing systems have been developed to provide content producers with tools for creating and editing electronic content independent of a platform of a target for displaying the electronic content. In PCT patent application publication no. WO2013/090298 (“SYSTEMS AND METHODS FOR CREATING, EDITING AND PUBLISHING CROSS-PLATFORM INTERACTIVE ELECTRONIC WORKS”), techniques are described to provide content producers with a set of one or more content viewing and editing tools to create a target-platform-independent representation of a digital content work. A product offered by Vjoon® corporation provides a unified publishing process enabling integrated management for a publishing platform. The product offers different layouts and individual pages to be previewed. Layout designers and editors can use the product to plan and research their layouts and articles. Despite the availability of tools and platforms to manage and create content, publishers are faced with challenges to transform electronic content for content having a layout desirable for display at different types of destinations (e.g., a mobile application and a social media Website). As a result of these challenges, publishers may be burdened with performing additional processing and/or implementing content workflow systems designed to produce and/or restructure content to a suitable layout for display or use by different destinations.

Publishers may still desire efficient ways to improve production workflow that enables electronic content to be produced for distribution to many different devices and publishing platforms. Publishers may also seek new and improved ways by which electronic content having a format may be transformed for display on different platforms such as social media applications, blogs, and media devices.

### BRIEF SUMMARY

A unified publishing platform (UPP) system is disclosed that can process electronic content (e.g., an electronic publication) to identify content data irrespective of the format of the electronic content. The content data is separated from formatting so that it can be reused to generate electronic content with different formats. The content data includes one or more content items (e.g., text and images). The content data is transformed to a format configured for display by one or more destinations (e.g., a mobile application, a content publishing platform, an advertising platform, a mobile device, or a social media Website). The UPP system transforms content data to a format based on consideration of a configuration (e.g., a display configuration) of a destination. A display configuration may indicate a configuration for displaying content at a destination. A display configuration may indicate display capabilities of a device representing a destination, a physical configuration of a display device corresponding to a destination, a format specification of a destination, or combinations thereof. By isolating the content data from formatted electronic content, the content data can be arranged for placement in a layout configured for a destination.

In some embodiments, the UPP system generates electronic content having a format using a template (e.g., a content workflow) selected by a user, or preferences regarding a layout (e.g., a content workflow) for displaying content. Using a template, electronic content is generated based on content data identified in electronic content. One or more attributes associated with the content data are used to identify content data for placement in a layout using a template. The template is selected based in part on the display configuration of the destination. By generating electronic content using the template, content producers can improve the efficiency of their content workflow for generating electronic content for different destinations. Content data separated from electronic content having formatting is reused to generate destination-specific content using a template.

The UPP system can process electronic content to identify content data as data that is not associated with style format data. In some embodiments, the electronic content is parsed to identify semantic data that identifies content data in the electronic content. The semantic data is associated with one or more attributes. The attribute(s) identify one or more content items in content data. The content data is extracted using the semantic data. In some embodiments, the semantic data is extracted with the content data. The semantic data can be stored in a semantic data store where the content data may be identified based on the attribute(s) associated with the semantic data. By identifying semantic data, content data devoid of formatting is identified for reuse for different templates. The ability to generate electronic content from content data lacking formatting may reduce time for content producers to implement a content workflow for different destinations. For display at different destinations, additional processing or restructuring of content may be implemented.

In some embodiments, the semantic data identified in electronic content enables content data to be aggregated based on one or more attributes corresponding to the semantic data. The semantic data further enables specific content items to be queried for specific subject matter based on which content items may be aggregated. The UPP system generates new electronic content based on the aggregated content data. The aggregated content data can be generated into electronic content based on a template and a configuration of a destination.

In some embodiments, the UPP system is implemented by a computing system. The computing system may be configured to implement methods and operations described herein. Yet other embodiments relate to systems and machine-readable tangible storage media which employ or store instructions for methods and operations described herein.

In at least one embodiment, a method is implemented by a computing system of the UPP system. The computing system may include memory storing semantic data extracted from a plurality of different electronic content. The method includes receiving first electronic content having a first format, wherein the first format has a first style for displaying the first electronic content. The method includes identifying a plurality of attributes of semantic data in the first electronic content. The plurality of attributes may include a title, a subtitle, an author, a body, and a set of images. The semantic data may identify content data in the first electronic content. The content data may include a plurality of content items. The method may include storing the semantic data in the memory. The method further includes extracting, from the first electronic content, the semantic data corresponding to the plurality of attributes. The method includes receiving a specification for displaying the content data at a destination. The specification may indicate an arrangement for displaying the content data corresponding to one or more of the plurality of attributes. The method includes determining a display configuration of the destination. The method further includes selecting, using the specification, a template from a plurality of templates for displaying the content data. Template may be selected from the plurality of templates using the display configuration. The method includes generating second electronic content using the display configuration and the selected template. The second electronic content includes the content data and the semantic data, and has a second format, the second format having a second style for displaying the content data. The method includes sending the second electronic content for display at the destination.

In at least one embodiment, identifying the plurality of attributes of the semantic data includes: identifying style format data of the first format in the first electronic content, the style format data including one or more style attributes defining the first style; and parsing, using the identified style format data, the first electronic content to identify each of the plurality of attributes. In some embodiments, the first format is a portable document format (PDF), wherein the second format is a hypertext markup language (HTML) format. The semantic data may be in a semantic HTML format.

In at least one embodiment, a destination may be one of a plurality of destinations. For example, one destination is a mobile device that displays the second electronic content in a Web application. In another example, a destination is a computing system that displays the second electronic content in a social media application.

In at least one embodiment, a template of the plurality of templates is created using one or more of HTML, cascade style sheets (CSS), or Javascript. Each of the plurality of templates may define a different editorial layout for displaying the content data.

In at least one embodiment, the method may include generating a graphical interface displaying the content data and a plurality of interactive elements. A first interactive element may receive a first input to configure the semantic data corresponding to one of the plurality of attributes. The input may indicate a value to change the semantic data corresponding to a first attribute of the plurality of attributes. A second interactive element may receive a second input indicating the specification for displaying the content data at the destination. The specification may indicate an attribute of a layout for displaying the content data.

In at least one embodiment, another method is implemented by a computing system of the UPP system. The method includes extracting first semantic data from first electronic content having a first style format. The first semantic data may correspond to a first plurality of attributes that define first content data in the first electronic content. The method includes extracting second semantic data from second electronic content having a second style format. The second semantic data may correspond to a second plurality of attributes that define second content data in the second electronic content. The method may include receiving a request to display content data. The request may indicate a specification for displaying the content data and the request indicates a value that identifies the content data. The method may include identifying third semantic data associated with an attribute having the value indicated by the request. The third semantic data may be identified based in part on the first semantic data and the second semantic data. The method may include determining a display configuration of a first destination of a plurality of destinations. The method may include selecting, using the specification, a template from a plurality of templates for displaying third content data identified by the third semantic data. The method may include generating, using the display configuration of the first destination and the selected template, third electronic content for display at the first destination. The third electronic content may include the third content data and has a third style format for displaying the third content data. The method may include sending the third electronic content for display at the first destination. In some embodiments, the first style format, the second style format, and the third style format may be different from each other.

In at least one embodiment, the value indicates a subject matter, and the third semantic data is identified by searching the semantic data store for semantic data associated with one or more attributes matching the subject matter.

In at least one embodiment, the method includes: determining a display configuration of a second destination of the plurality of destinations, wherein the second destination is distinct from the first destination; and generating, using the display configuration of the second destination and the selected template, fourth electronic content for display at the second destination. The fourth electronic content may include the third content data and has a fourth style format for displaying the third content data. The method may include sending the fourth electronic content for display at the second destination.

In at least one embodiment, the method may further include: storing, to a semantic data store, the first semantic data in association with the first plurality of attributes and storing, to the semantic data store, the second semantic data in association with the second plurality of attributes. Identifying the third semantic data may include searching the semantic data store for semantic data corresponding to an attribute having the value indicated by the request. The third semantic data may include the first semantic data and the second semantic data corresponding to the attribute.

In at least one embodiment, the first electronic content may correspond to a first editorial article. The second electronic content may correspond to second editorial article that different from the first editorial article.

The foregoing, together with other features and embodiments will become more apparent upon referring to the following specification, claims, and accompanying drawings.

### BRIEF DESCRIPTION OF THE DRAWINGS

Illustrative embodiments of the present invention are described in detail below with reference to the following drawing figures:

FIG. 1 shows a block diagram of a content publishing system according to an embodiment of the present invention.

FIG. 2 shows a more detailed high level diagram of a content publishing system according to some embodiments of the present invention.

FIG. 3 illustrates a detailed high-level diagram of a content publishing system that extracts semantic content from electronic content according to some embodiments of the present invention.

FIG. 4 shows a block diagram of client system according to an embodiment of the present invention.

FIG. 5 illustrates an example of electronic content having format data for displaying content data according to some embodiments of the present invention.

FIG. 6 shows an example of a data record in a semantic data store according to some embodiments of the present invention.

FIG. 7 illustrates an example of contents of a semantic data store according to some embodiments of the present invention.

FIG. 8 illustrates a flowchart of a process for transforming electronic content for display at a destination according to some embodiments of the present invention.

FIG. 9 illustrates a flowchart of a process for transforming electronic content for display at a destination according to some embodiments of the present invention.

FIG. 10 illustrates a graphical interface to configure semantic data for publishing according to some embodiments of the present invention.

FIG. 11 illustrates a graphical interface for displaying content data based on a configuration for publishing content according to some embodiments of the present invention.

FIG. 12 illustrates a graphical interface for displaying content data based on a configuration for publishing content according to some embodiments of the present invention.

FIG. 13 illustrates a graphical interface for displaying content data based on a configuration for publishing content according to some embodiments of the present invention.

FIG. 14 shows a simplified block diagram of a representative computing system and client computing system usable to implement certain embodiments of the present invention.

### DETAILED DESCRIPTION

In the following description, for the purposes of explanation, specific details are set forth in order to provide a thorough understanding of embodiments of the invention. However, it will be apparent that various embodiments may be practiced without these specific details. For example, circuits, systems, algorithms, structures, techniques, networks, processes, and other components may be shown as components in block diagram form in order not to obscure the embodiments in unnecessary detail. The figures and description are not intended to be restrictive.

### Overview of Unified Publishing Platform (UPP) System

Certain embodiments of the present invention provide techniques for transforming electronic content for publishing at different types of destinations. A UPP system is disclosed that can process electronic content (e.g., an electronic publication) to separate content data from formatting so that the content data can be transformed to electronic content that can be displayed or used at different destinations. Examples of destinations may include, without restriction, an mobile application, a computing device (e.g., a mobile phone or a tablet device), a content management system (CMS), a third party content publishing platform (e.g., LinkedIn®, Medium®, Facebook®, or Flipboard®), an advertising platform (e.g., Nativio®), a content distribution system, or a partner channel system for distributing content.

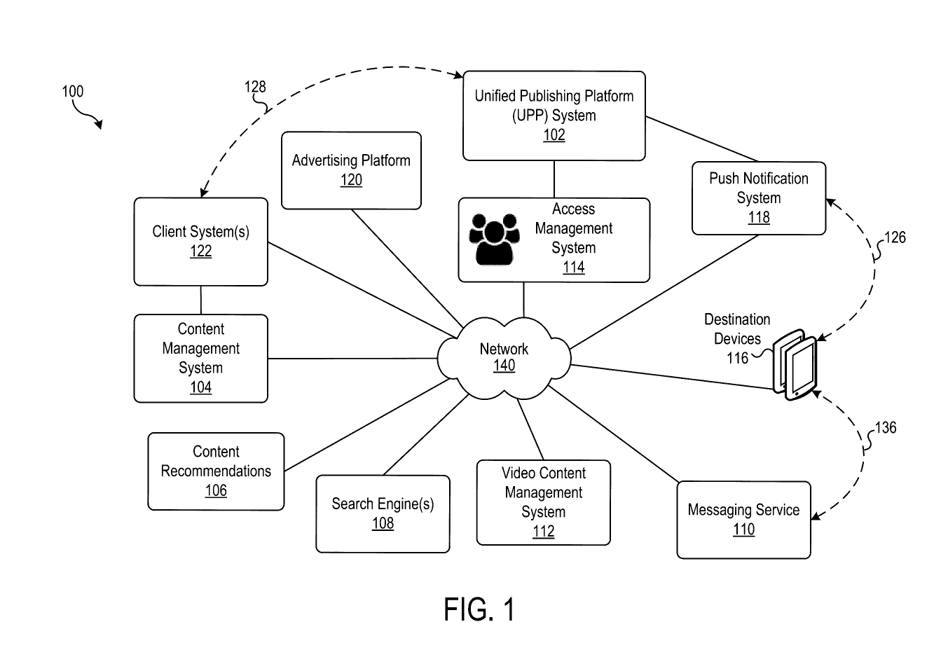

FIG. 1 shows a block diagram of a content publishing system 100 according to an embodiment of the present invention. Content publishing system 100 may include UPP system 102, one or more client systems 122 (referred to herein as “client system” or “client publisher system”), and one or more destinations, such as one or more destination devices 116 (herein referred to as “destination device”).

UPP system 102 may be implemented using a computing system. UPP system 102 may transform electronic content (e.g., an electronic publication) to be displayed at a variety of different destinations. Prior to transformation by UPP system 102, electronic content may have a format for displaying the electronic content. The format may be defined by an arrangement (e.g., a content workflow) for displaying content data in the electronic content. For purposes of illustration, electronic content described herein includes content data that is in an electronic format. Content data may include one or more electronic content items (e.g., text and images). Regardless of the structure or format of electronic content, UPP system 102 may transform content data in electronic content into a format that may be suitable for display by a device depending on a configuration for display of a destination.

In some embodiments, electronic content may be transformed to a format defined by a configuration (e.g., a specification) of a destination. Based on the configuration, the destination may be able to perform further processing on the electronic content transformed by UPP system 102 for display by the destination. UPP system 102 may enable a content publisher to distribute electronic content for publication to many different destinations without having to ensure that the electronic content conforms to a configuration defined by one particular destination. In some embodiments, content data in electronic content having a specific content workflow may be processed by UPP system 102 to generate new electronic content that is adjusted to a workflow suitable for a specific destination.

Content data may include one or more electronic content items. A content item may be one or more types of content, including, but not limited to, electronic data corresponding to text, an image, a video, audio, other electronic media content, or the like. Content data in electronic content may be unstructured, structured, or a combination thereof. Electronic content may be defined based on one or more formats. Electronic content may be defined as having a format using, without limitation, hypertext markup language (HTML), cascade style sheets (CSS), Javascript, or other formatting techniques and languages. A format may indicate a style for displaying electronic content. As such, electronic content may include style format data that indicates a format of content data.

In some embodiments, electronic content may include semantic content that identifies one or more content items in the electronic content. The semantic content is electronic data that indicates a meaning of content data in the electronic content. For example, semantic content may identify a content item in electronic content in relation to other content items. Semantic content may indicate that the content item (e.g., text) is associated with a particular attribute (e.g., a title) in an article. Semantic content may be defined by electronic semantic data. In some embodiments, semantic data may include semantic metadata. Semantic data may be defined using a semantic language (e.g., semantic HTML) or other language that conveys a meaning for content data. Semantic data may include one or more attributes that identify content data in electronic content. The attribute(s) may be user defined to identify specific content.

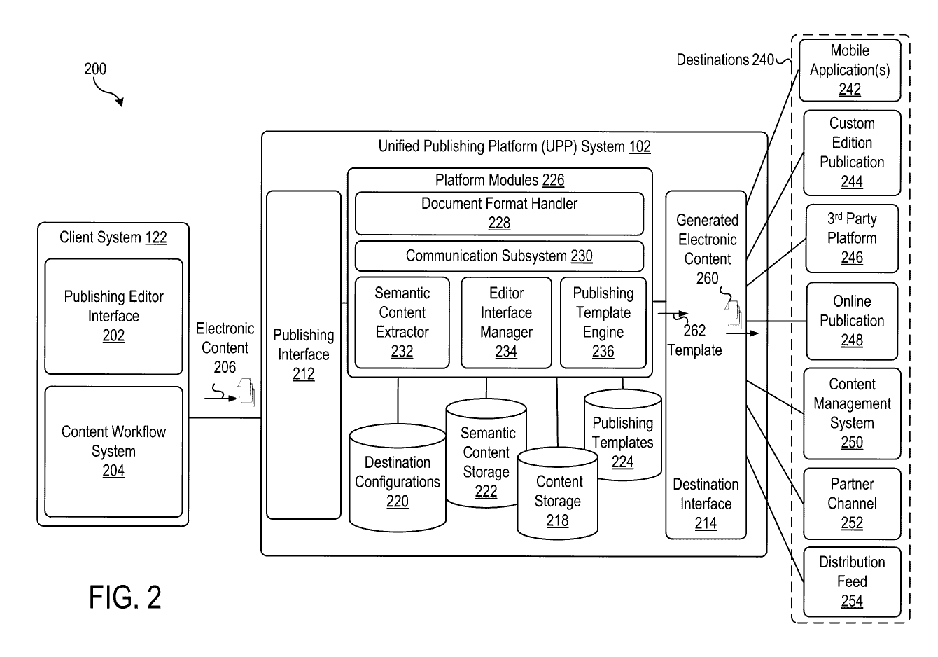

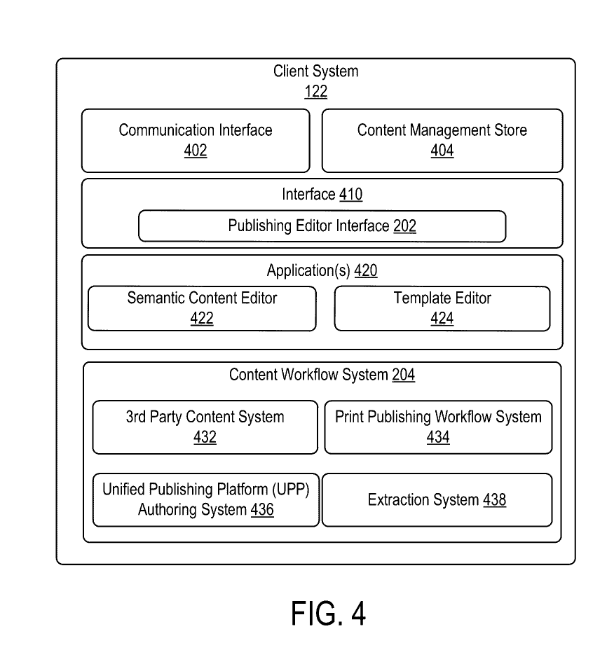

UPP system 102 may receive electronic content from one or more sources including, without limitation, CMS 104 and client system 122 of content publishing system 100. Client system 122 is further described below with reference to FIGS. 2 and 4. CMS 104 may be implemented by a third party provider or may be controlled by client system 122 operated by a user (e.g., a publisher of content). In some embodiments, CMS 104 may store electronic content created by a publisher, aggregated from other sources, or a combination thereof. Electronic content provided by a publisher and/or CMS 104 may have a content workflow that is defined for a particular display. The content workflow may be defined based on the semantic content in the electronic content. Described below with reference to FIGS. 2-4 are examples of sources from which electronic content may be received by UPP system 102 for transformation.

UPP system 102 may transform electronic content into electronic content for delivery to multiple types of destinations. UPP system 102 may process electronic content to identify and extract semantic data from style format data defining a format for content data. A template may be selected for displaying the semantic content at one or more destinations. The template may be chosen, for example, based on different criteria including input received from a user (e.g., a publisher), a display configuration, information about the semantic content, or combinations thereof. Based on a destination to receive the electronic content, electronic content may be generated using the template to display semantic content at the destination.

In at least one embodiment, electronic content data having a format (e.g., a format having a style for displaying electronic content) is received by UPP system 102 from a client system (e.g., client system 122). The electronic content is processed to identify semantic data. The semantic data may have one or more attributes that identify content data in the received electronic content. UPP system 102 may perform processing to extract the semantic data from the received electronic content. UPP system 102 receives from client system 122 a specification that indicates preferences for determining a template to display the content data (e.g., the content data identified by the semantic data) at a destination. The specification may be used by UPP system 102 to select a template from a plurality of templates for displaying the content data. A display configuration is determined for the destination. Using the display configuration and the selected template, UPP system 102 generates electronic content that is transformed based on the electronic content received from client system 122. The electronic content may be generated to include the semantic data and the content data. The electronic content may have a format suitable for displaying the content data at the destination. The format may have a style for displaying the content data at the destination. The electronic content, once generated, may be sent to the destination for display by at the destination. Further details and other processes of UPP system 102 are described below at least with reference to FIGS. 2, 3, 8, and 9.

In some embodiments, content publishing system 100 may include one or more communication systems, such as messaging service 110 and/or push notification system 118, for communication of electronic content transformed by UPP system 102. Such communication systems may be used by UPP system 102 to send transformed electronic content to one or more destinations. These communication systems may be requested to send notifications about electronic content that has been generated by UPP system 102 and/or about a location where the generated electronic content may be accessed.

Examples of messaging services (e.g., messaging service 110) may include email services such as Gmail™ (a service of Google Inc.) and Yahoo!® Mail (a service of Yahoo! Inc.). Other examples may include instant messaging or chat services such as Gmail's chat feature or Facebook's chat (a service of Facebook, Inc.), SMS/MMS services provided by cellular data carriers, social network services with a messaging component (e.g., social networks provided by Facebook, Inc., or LinkedIn Corp.). Using messaging service 110, UPP system 102 may communicate (e.g., indicated by dashed arrow 136) a message to a destination such as destination device 116. The message may include electronic content transformed by UPP system 102 for display by destination device 116. In some embodiments, a message may provide a notification of an availability of electronic content generated by UPP system 102. The electronic content may be accessed from a content store (e.g., a semantic data store) provided by UPP system 102. A “message” may include any electronic communication generated by a sender and directed to one or more recipients, such as email messages, instant messages (e.g., messages sent between users using various “chat” services), SMS/MMS messages (e.g., messages conforming to Short Messaging Service and/or Multimedia Messaging Service protocols supported by various cellular and other wireless data networks), voice messages, photo/image messages, social network messages, and so on.

Push notification system 118 may implement a push notification service (e.g., Apple push notification service provided by the Apple® corporation or Google notification service provided by the Google® corporation). The push notification service may facilitate communication between UPP system 102 and one or more destinations including destination devices 116. The push notification service may deliver transformed electronic content or a notification about the electronic content. For example, UPP system 102 may send a push notification (e.g., indicated by dashed arrow 126) to destination device 116 when electronic content has been generated and is available for access. Destination devices 116 may be configured to communicate with push notification system 118 to pull any such notifications about electronic content or push any requests for notifications to UPP system 102. In some embodiments, UPP system 102 may provide one or more graphical interfaces to view and manage push notifications for electronic content. A user may customize notifications, e.g., schedule new custom push notifications or make changes to existing scheduled push notifications, before the scheduled start time.

In some embodiments, UPP system 102 may manage access to UPP system 102 through access management system 114. Access management system 114 may manage access to electronic content generated by UPP system 102. Access management system 114 may provide identity administration for use of UPP system 102. The identity administration may be used to control providing access to electronic content to UPP system 102, managing notifications about electronic content, and other features of UPP system 102 described herein.

UPP system 102 may provide other services and/or software applications in a virtual or non-virtual computing environment. UPP system 102 may be configured to run one or more of these services or software applications described in the foregoing disclosure. The services may be offered on-demand as cloud-based or web-based services to users of client systems, e.g., client system 122. Client system 122 may be communicatively coupled 128 to UPP system 102. The services may be provided via a communication network (e.g., network 140), such as the Internet. Users operating client system 122 may use one or more applications to interact with UPP system 102 to utilize the services or applications provided by UPP system 102. Services may be offered as a self-service or a subscription. In some embodiments, a specific instantiation of a service provided by UPP system 102 may be referred to herein as a “service.” A service made available to a user via network 140 (e.g., a communication network) from UPP system 102 is referred to as a “cloud service.” In some embodiments, UPP system 102 may host an application, and a user may, via network 140, access the application at client system 122 on demand.

Video content management system (CMS) 112 in content publishing system 100 may provide video content services for UPP system 102 to deliver electronic content to users at client systems. In some embodiments, video CMS 112 may be implemented by a third party provider. Video CMS 112 may provide services and applications to enable broadcast quality playback on all types of devices, video hosting and streaming, content management and syndication. Using video content management system 112, UPP system 102 may enable a publisher to optimize its video workflows. Video CMS 112 may provide an application or a graphical interface to publish video content into your publication and seamlessly play them online or in the application.

Advertising platform 120 in content publishing system 100 may provide advertising services for UPP system 102. For example, advertising platform 120 may provide electronic content (e.g., advertising content) to UPP system 102 for display with electronic content for display at different destinations. Examples of advertising content may include, without limitation, video, text, images, audio, or combinations thereof. Advertising platform 120 may provide an application and/or one or more graphical interfaces to provide input to configure display of advertising content. In some embodiments, advertising platform 120 may select a template for displaying advertising content with electronic content generated by UPP system 102. The advertising content received from advertising platform 120 may be integrated into electronic content received from one or more content sources such as CMS 102 or client system 122.

In some embodiments, UPP system 102 may provide search services. UPP system 102 may communicate with one or more search engine(s) 108 (herein referred to as “search engine”) for distribution of electronic content generated by UPP system 102. For example, electronic content may be generated by UPP system 102 for distribution via search engine 108. Electronic content may be formatted for search engine optimization. In some embodiments, UPP system 102 may provide an application and/or one or more graphical interfaces to configure preferences for distribution of electronic content via search engine 108.

UPP system 102 may provide content recommendation services. In at least one embodiment, UPP system 102 may communicate with a content recommendation system 106 (referred to herein as “content recommendations”) to obtain content recommendations for electronic content provided by a publisher. Content recommendations 106 may be determined based on behavioral data about users that access electronic content through UPP system 102. In some embodiments, UPP system 102 may generate content for delivery to destinations based content recommendations. For example, a format of electronic content may be adjusted based on behavioral data that indicates interests of a recipient of the electronic content. In some embodiments, content may be omitted or added based on behavioral data about a recipient of electronic content.

### High-Level View of UPP System

FIG. 2 shows a more detailed high level diagram of a content publishing system 200 according to some embodiments of the present invention. Specifically, content publishing system 200 illustrates the functions and features of UPP system 102. UPP system 102 may transform electronic content received from client system 122. As explained above, client system 122 may be operated by a user (e.g., a content producer). A content producer may include a content publisher, an author, an advertiser, a writer, or other party that publishes electronic content. The electronic content (e.g., electronic content 206) received from client system 122 may have formatting. Electronic content 206 may be formatted according to a content workflow (e.g., a layout of a publication) for displaying content.

In some embodiments, client system 122 may include content workflow system 204 that generates electronic content 206. Content workflow system 204 may implement one or more content workflows to generate a content layout for electronic content 206. Examples of content workflow systems are further described below for client system 122 with reference to FIG. 4.

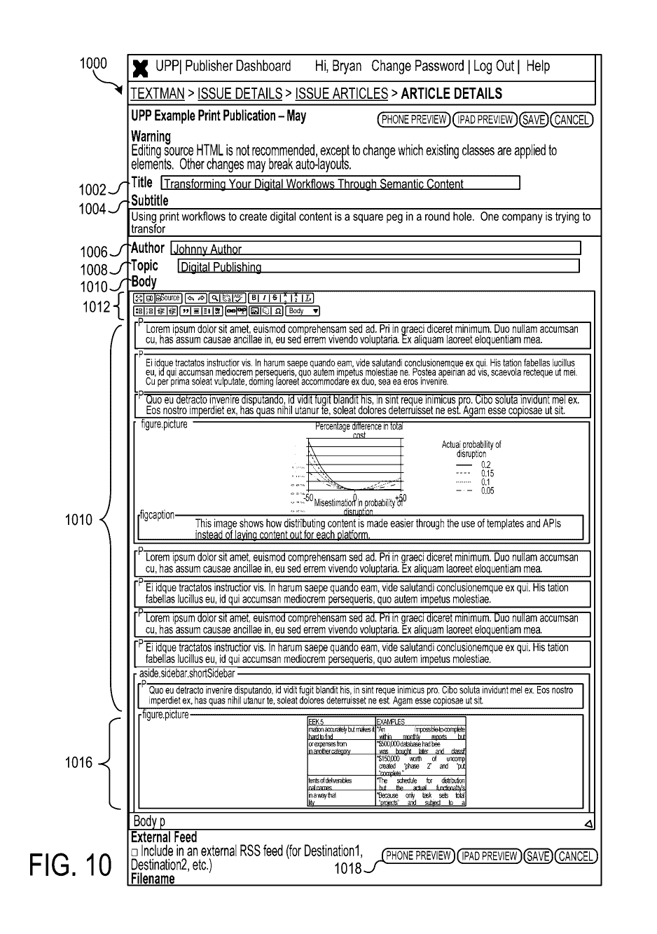

Client system 122 may provide an interface (e.g., a graphical interface) to access UPP system 102. For example, client system 122 may provide a publishing editor interface 202 to configure content in electronic content 206. Examples of functions using publishing editor interface 202, include among other functions, omitting and/or adding content, configuring semantic data defining semantic content in electronic content 206, selecting a template for displaying electronic content 206, and selecting one or more destinations for displaying electronic content 206. Publishing editor interface 202 is further described with reference to FIGS. 4 and 10. Publishing editor interface 202 may display semantic content in electronic content 206 based on processing performed on electronic content 206 by UPP system 102.

UPP system 102 may be implemented using a computer system, which may comprise one or more computers and/or servers which may be general purpose computers, specialized server computers (including, by way of example, PC servers, UNIX servers, mid-range servers, mainframe computers, rack-mounted servers, etc.), server farms, server clusters, distributed servers, or any other appropriate arrangement and/or combination thereof. The computing system that makes up UPP system 102 may run any of operating systems or a variety of additional server applications and/or mid-tier applications, including HTTP servers, FTP servers, CGI servers, Java servers, database servers, and the like. Exemplary database servers include without limitation those commercially available from Microsoft, and the like. UPP system 102 may be implemented using hardware, firmware, software, or combinations thereof. In one example, UPP system 102 may be included a product such as unified publishing platform, provided by GTxcel® Corporation. In various embodiments, UPP system 102 may be configured to run one or more services or software applications described in the foregoing disclosure. For example, UPP system 102 may correspond to a computing system for performing processing as described herein according to an embodiment of the present disclosure.

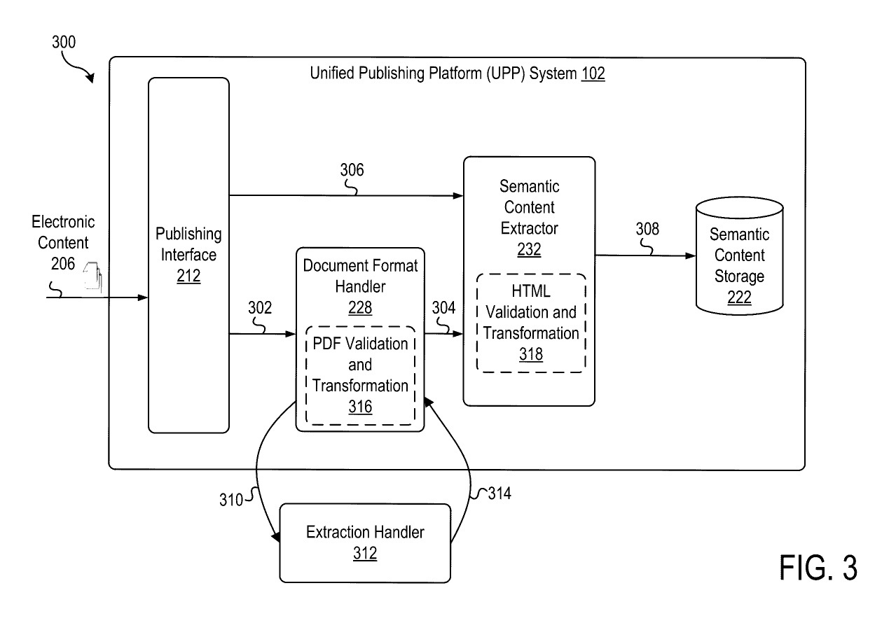

In some embodiments, UPP system 102 may be implemented using a cloud infrastructure system comprising one or more computers and/or servers that may include those described above. UPP system 102 may include several subsystems and/or modules, including some, which may not be shown. UPP system 102 may have more or fewer subsystems and/or modules than shown in the figure, may combine two or more subsystems and/or modules, or may have a different configuration or arrangement of subsystems and/or modules. In some embodiments, UPP system 102 may include publishing interface 212, platform modules 226, destination interface 214, and a plurality of data stores including destination configurations 220, semantic content storage 222, content storage 218, and publishing templates 224. Platform modules 226 may include document format handler 228, communication subsystem 230, semantic content extractor 232, editor interface manager 234, and publishing template engine 236. Some of the operations performed by UPP system 102 may be performed as a manual process, which can be implemented by a human operator. Some embodiments of UPP system 102 are described further below with reference to FIG. 3. Subsystems and modules of UPP system 102 may be implemented in software (e.g., program code, instructions executable by a processor), in hardware, or combinations thereof. In some embodiments, the software may be stored in a memory (e.g., a non-transitory computer-readable medium), on a memory device, or some other physical memory and may be executed by one or more processing units (e.g., one or more processors, one or more processor cores, one or more GPUs, etc.).

In certain embodiments, UPP system 102 may also provide other services or software applications can include non-virtual and virtual environments. In some embodiments, these services may be offered as web-based or cloud services or under Software as a Service (SaaS) model to the users of client system 122. The services offered by UPP system 102 may include, without limitation, application services, platform services and infrastructure services. In some examples, application services may be provided by UPP system 102 via a SaaS platform. The SaaS platform may be configured to provide services that fall under the SaaS category. The SaaS platform may manage and control the underlying software and infrastructure for providing the SaaS services. By utilizing the services provided by the SaaS platform, customers can utilize applications executing in UPP system 102, which may be implemented as a cloud infrastructure system. Users can acquire the application services without the need for customers to purchase separate licenses and support. Various different SaaS services may be provided. Users operating client system 122 may in turn utilize one or more applications to interact with UPP system 102 to utilize the services provided by subsystems and/or modules of UPP system 102.

UPP system 102 may include at least one memory, one or more processing units (or processor(s)), and storage. The processing unit(s) may be implemented as appropriate in hardware, computer-executable instructions, firmware, or combinations thereof. Computer-executable instructions or firmware implementations of the processing unit(s) may include computer-executable or machine-executable instructions written in any suitable programming language to perform the various operations, functions, methods, and/or processes described herein. The memory in UPP system 102 may store program instructions that are loadable and executable on the processing unit(s), as well as data generated during the execution of these programs. The memory may be volatile (such as random access memory (RAM)) and/or non-volatile (such as read-only memory (ROM), flash memory, etc.). The memory may be implemented using any type of persistent storage device, such as computer-readable storage media. In some embodiments, computer-readable storage media may be configured to protect a computer from an electronic communication containing malicious code. The computer-readable storage media may include instructions stored thereon, that when executed on a processor, perform the operations described herein.

UPP system 102 may also include or be coupled to additional storage, which may be implemented using any type of persistent storage device, such as a memory storage device or other non-transitory computer-readable storage medium. In some embodiments, local storage may include or implement one or more databases (e.g., a document database, a relational database, or other type of database), one or more file stores, one or more file systems, or combinations thereof. For example, UPP system 102 may be coupled to or may include one or more data stores, e.g., destination configurations 220, semantic content storage 222, content storage 218, and publishing templates 224. The memory and the additional storage are all examples of computer-readable storage media. For example, computer-readable storage media may include volatile or non-volatile, removable or non-removable media implemented in any method or technology for storage of information such as computer-readable instructions, data structures, program modules, or other data.

Publishing interface 212 may communicate with multiple instances of client systems 122 (e.g., clients associated with different users and/or multiple clients systems associated with the same user). For example, publishing interface 212 may be configured to receive electronic content (e.g., electronic content 206) from one or more client systems, e.g., client system 122. In some embodiments, one or more communication protocols (e.g., a custom protocol or an HTTP-based protocol) may be supported by publishing interface 212 to facilitate communication between client system 122 and UPP system 102. Publishing interface 212 may be configured to communicate with applications on client system 122 to receive electronic content. Such applications may be provided by UPP system 102 to facilitate providing electronic content 206 according to a protocol supported by UPP system 102.

In some embodiments, publishing interface 212 may be defined by a programming interface (e.g., an application programming interface (API)). The programming interface may include callable functions to provide electronic content from one or more client systems. The programming interface may support electronic content have different types of formats, different file types, or other different types of electronic content. In some embodiments, the programming interface may receive semantic data defining content data alternatively or in addition to electronic content that is formatted with semantic content.

In at least one embodiment, a programming interface of publishing interface 212 may be defined by a specification for receiving electronic content. In some embodiments, the specification may define one or more input parameters for receiving content data. Each parameter may correspond to content data associated with an attribute of semantic data. Below is an example of parameters for receiving content data:

| | |
|---|---|
| a. | “articleId”: 0, |
| b. | “title”: “ ”, |
| c. | “content”: “ ”, |
| d. | “description”: “ ”, |
| e. | “publishedDate”: “ ”, |
| f. | “created”: “ ”, |
| g. | “modified”: “ ”, |
| h. | “articleType”: { |

“articleTypeId”: 0,
“name”: “ ”,
“publicationId”: 0,
“createdBy”: 0,
“created”: “ ”,
“modified”: “ ”
},

| | |
|---|---|
| i. | “publicationId”: 0 |

Client system 122 may provide semantic content to UPP system 102 through a programming interface of publishing interface 212. In some embodiments, an application accessible at client system 122 may receive input defining semantic content, and the semantic content may be sent by client system 122 using publishing interface 212.

In some embodiments, electronic content may be provided by a third party (e.g., a publisher) for storage. Publishing interface 212 may be configured to receive electronic content for processing by UPP system 102. Electronic content received from a third party may be stored in content storage 218.

Platform modules 226 may include a communication subsystem 230 that may manage communication with client system 122, one or more destinations 240 (herein referred to as “destinations”), and/or communications within UPP system 102. Communication subsystem 230 may communicate within UPP system 102, client system 122, and/or destinations 240 by sending and receiving messages. A “message” may include any electronic communication generated by a sender and directed to one or more recipients. Communication subsystem 230 may be implemented with a communication interface (e.g., a programming interface) that translates communications between various different subsystems and/or modules in UPP system 102. The communication interface may be configured with one or more parameters to send and/or receive communications. In some embodiments, communication subsystem 230 may communicate using one or more third party communication systems or services, such as email services, SMS/MMS services provided by cellular data, or other wireless data networks.

Communication subsystem 230 may communicate using one or more communication networks of various types. Examples of communication networks include, without restriction, the Internet, a wide area network (WAN), a local arear network (LAN), an Ethernet network, a public or private network, a wired network, a wireless network, and the like, and combinations thereof. Different communication protocols may be used to facilitate the communications including both wired and wireless protocols such as IEEE 802.XX suite of protocols, TCP/IP, IPX, SAN, AppleTalk, Bluetooth®, and other protocols.

UPP system 102 may communicate transformed electronic content (e.g., generated electronic content 260) to destinations 240. As discussed above, destinations 240 may include, without restriction, mobile applications 242, a Web server of a service provider that may distribute a custom edition publication 244, third party platforms 246 (e.g., LinkedIn®, Medium®, Facebook®, or Flipboard®), online publications 248, CMS 250, partner channel 252, and distribution feeds 254. Destinations 240 may be at a computing device or a server system that presents electronic content for display. Third party platforms 246 may include an advertising platform, such as Nativio®. A partner channel 252 may be implemented by a computing environment that receives electronic content for distribution by a third party (e.g., a business partner of a publisher). The computing environment may include an interface to provide electronic content (e.g., generated electronic content 260) generated by UPP system 102.

In some embodiments, one or more of destinations 240 may define an interface (e.g., a programming interface) having a specification for receiving generated electronic content 260. Content 260 may be generated according to the specification of a destination 240. A destination 240 may display generated electronic content 260 received from UPP system 102.

Document format handler 228 may perform processing on electronic content 206 to prepare electronic content for processing by semantic content extractor 232. In one example, document format handler 228 may process electronic content 206 to remove formatting (e.g., style format data) in electronic content 206. In some embodiments, electronic content 206 may be processed by document format handler 228 to convert electronic content 206 from one format to another format more suitable for semantic content extraction as described herein. For example, electronic content 206 in a portable document format (PDF) format may be processed to produce electronic content having an HTML format. A third party application may be used to aid in processing of electronic content 206.

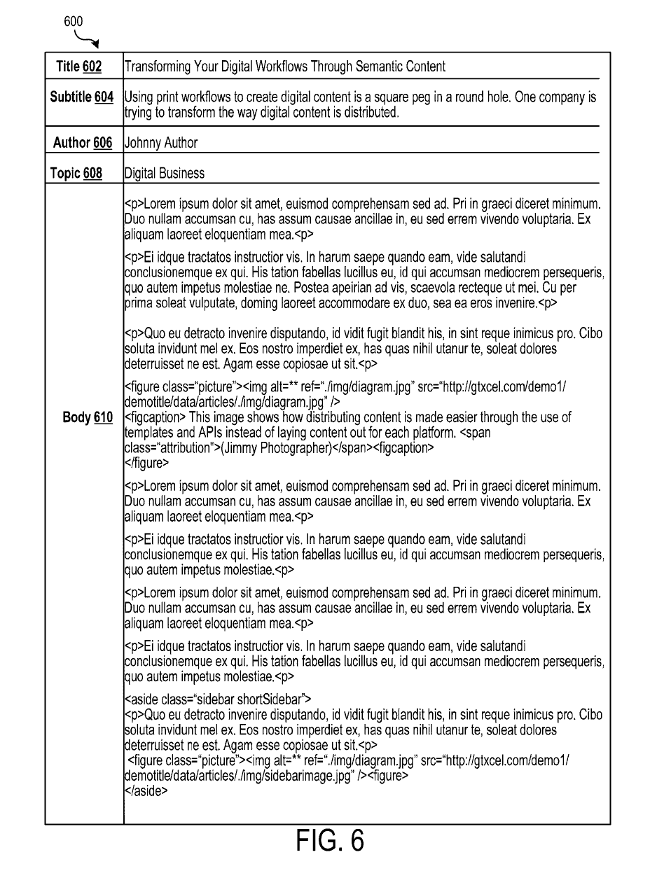

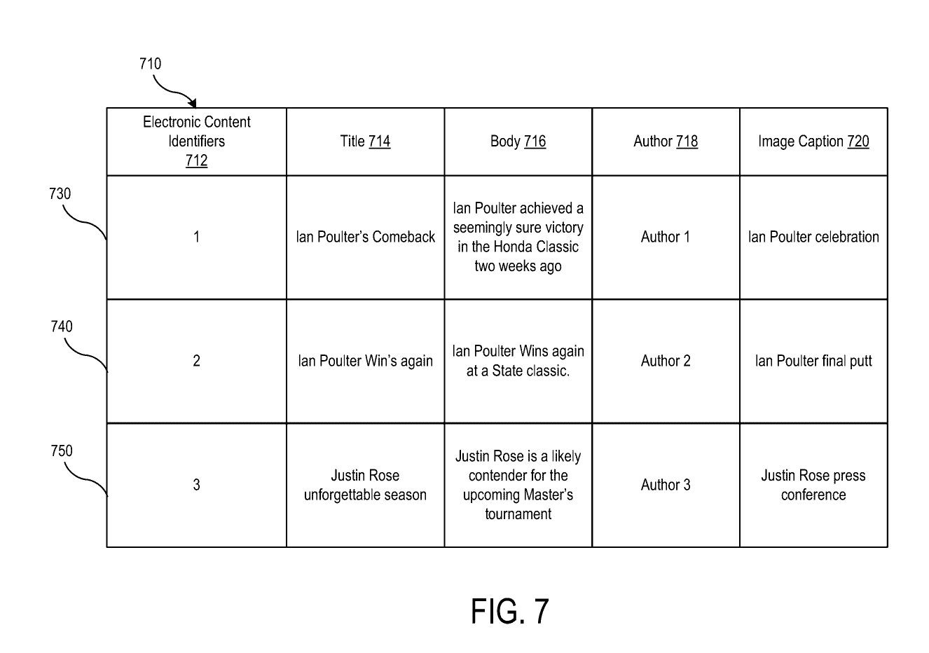

Semantic content extractor 232 may perform processing on electronic content to identify semantic data corresponding to semantic content in electronic content 206. Semantic content extractor 232 may process electronic content 206 received from client system 122 and/or electronic content produced by document format handler 228 based on electronic content 206. Semantic content extractor 232 may identify semantic data in electronic content. Examples of semantic data are described with reference to FIGS. 6 and 7. In some embodiments, the operations performed by semantic content extractor 232 may be performed manually by a human operator. Specifically, a plurality of attributes of semantic data may be identified in electronic content. Attributes may include, without limitation, a title of electronic content, a subtitle of electronic content, an author (e.g., a byline) of electronic content, a body of electronic content, one or more images, and one or more captions associated with an image. In some embodiments, electronic content may include little or no formatting (e.g., stylistic formatting), such that semantic content extractor 232 may not have performed processing to extract semantic content. Semantic data may be identifiable in the electronic content because there is little or no formatting.

In at least one embodiment, semantic content extractor 232 may identify a plurality of attributes in electronic content by parsing the first electronic content. For example, when the format of the first electronic content is based on HTML, the HTML may be parsed to identify style format data (e.g., HTML) associated with the first style of the format. Based on identifying the style format data, semantic data that identifies content data in the electronic content may be identified as not being a part of the style format data. Semantic data may be in a format such as semantic HTML or other metadata format. The semantic data may not be included in the format of the electronic content if format data exists in electronic content processed by semantic content extractor 232. The format of semantic data may be predefined by a specification such that electronic content 206 is coded using the format.

Semantic content storage 222 may store semantic data that identifies content data. In some embodiments, the content data identified by the semantic data may be stored in semantic content storage 222. In some embodiments, the semantic data in semantic content storage 222 may reference the content data, which may be stored elsewhere, such as content storage 218. Examples of semantic content storage 222 are described with reference to FIG. 7. In some embodiments, semantic data received via publishing interface 212 may be stored directly in semantic content storage 222 without performing additional processing to identify semantic content.

UPP system 102 may provide one or more interfaces (e.g., graphical interfaces) to access and/or operate UPP system 102. Editor interface manager 234 may manage providing such interfaces to client system 122. Graphical interfaces, such as those described with reference to interface described in FIG. 10 may be provided as part of an application enabling access to UPP system 102. Editor interface manager 234 may generate an interface to enable a user to modify (e.g., omit, add, or update) semantic content, such as semantic content in semantic content storage 222 or semantic content extracted by semantic content extractor 232.

In some embodiments, editor interface manager 234 may generate a user interface that enables a user to provide input to select a template for generating a layout to display content data. Templates may be accessed from publishing templates 224. Editor interface manager 234 may generate an interface that enables a user to access these templates and select one suitable for a destination. In some embodiments, templates may be presented for selection based on the destination. An interface provided by editor interface manager 234 may enable a user to specify a destination for displaying content data.

Publishing template engine 236 may select a template 262 indicating a layout for displaying content data. The content data may include content data identified by semantic data extracted from electronic content (e.g., electronic content 206). The template may be selected based on input received through an interface generated by editor interface manager 234. In some embodiments, a template may be selected automatically. A template may be selected based on one or more layout preferences provided by a user through an interface. A template may be selected based on a display configuration of a destination. In some embodiments, template 262 may be generated if a template is not identified in publishing templates 224.

In some embodiments, publishing templates data store 224 may store one or more templates defining a layout for display content data. All or some of these templates may be pre-defined. In some embodiments, a template may be defined based on a configuration of a destination (e.g., a display configuration). One or more templates may define an editorial layout for displaying content data. One or more templates may be created using Web technologies such as HTML, CSS, Javascript, or a combination thereof.

Destination interface 214 may perform processing to generate electronic content 260 using template 262. Destination interface 214 may generate electronic content having a format suitable for displaying content data identified by semantic data (e.g., semantic data extracted by semantic content extractor 232). The content data may have been identified in electronic content 206 or may have been accessed from content storage 218.

Destination interface 214 may generate electronic content 260 based on a destination configuration of one of destinations 240 chosen to display generated electronic content 260. A destination configuration may be identified in destination configurations 220 based on the destination selected for displaying electronic content. Destinations may have different configurations. The destination configuration may include a display configuration for displaying electronic content at a destination. A display configuration may indicate display capabilities of a device representing a destination, a physical configuration of a display device corresponding to a destination, a format specification of a destination, or combinations thereof. The display configuration may be based on one or more factors for display including a size of a display device, a type of a display device, or other factors related to displaying content at a destination.

In some embodiments, destination configuration may indicate a specification of the destination including an application that will display electronic content. The specification may indicate one or more parameters for providing the electronic content. In some embodiments, the parameters may indicate specific attributes of content such that content data may be provided according to the parameters rather than generating electronic content 260. By identifying semantic data corresponding to content data, content data may be provided based on the attributes corresponding to the semantic data rather than generating electronic content having a layout.

Electronic content 260 may be generated according to a layout that satisfies template 262 and considers the display configuration. The format of electronic content 260 may vary based on the template and/or a configuration of the destination. In some embodiments, different versions of electronic content 260 may be generated for different destinations that have different configurations. Destination interface 214 may send electronic content 260 to one or more destinations 240 for which electronic content 260 is generated.

### Examples of Processing Flow in UPP System

FIG. 3 illustrates a detailed high-level diagram of a content publishing system 300 that extracts semantic content from electronic content (e.g., electronic content 206) according to some embodiments of the present invention. Content publishing system 300 may include UPP system 102 of FIGS. 1 and 2. At least some embodiments shown in FIG. 3 illustrate operations performed by UPP system 102 for processing electronic content 206 to produce semantic content 308 for storage in semantic content storage 222.

As discussed above, electronic content 206 may be received from one or more sources including client system 122. Electronic content 206 received via publishing interface 212 may be provided 306 to semantic content extractor 232 to perform operations implementing semantic content extraction. In some embodiments, electronic content 206 may be provided to semantic content extractor 232 based on a format of electronic content 206. In some embodiments, a format of electronic content 206 may not be suitable for processing to identify semantic content. As such, electronic content 206 may be provided 302 to document format handler 228 before semantic content extractor 232. Electronic content 206 may be provided to document format handler 228 based on determining that electronic content 206 has a particular format (e.g., PDF) that demands additional processing. Whereas, based on determining that electronic content is in a particular form (e.g., HTML format), electronic content 206 may be provided 306 directly to semantic content extractor 232.

Document format handler 228 may perform operations for validation and transformation of electronic content 206 to a format suitable for performing semantic content extraction. For example, when electronic content 206 has a PDF format, document format handler 228 may implement a PDF validation and transformation process 316. Process 316 may validate the format of electronic content 206 as a PDF format and may transform (e.g., convert) electronic content 206 to a different format (e.g., HTML) suitable for identifying semantic content. Document format handler 228 may generate data 304 that is sent to semantic content extractor 232.

In some embodiments, document format handler 228 may request 310 an external extraction handler 312 to perform operations for extraction of content data from electronic content 206. For example, extraction handler 312 may perform processing on electronic content 206 to remove format data corresponding to a format (e.g., PDF) of electronic content 206. Extraction handler 312 may send 314 extracted electronic content to document format handler 228. Document format handler 228 may transform content data received 314 from extraction handler 312 to a format suitable for content extraction.

Semantic content extractor 232 may perform operations to implement a semantic content extraction process as described herein. In some embodiments, semantic content extractor 232 may implement a validation and transformation process (e.g., HTML validation and transformation 318) to transform electronic content to a format for storage in semantic content storage 222. For example, electronic content received in an HTML format (e.g., electronic content 306 or electronic content 304) may be processed to extract semantic content from the electronic content. Semantic content extractor 232 may parse electronic content to determine whether it is in a suitable format (e.g., HTML) for semantic content extraction. Specifically, electronic content may be parsed to determine whether content data is formatted according to a particular language.

Upon validation of the format, electronic content may be processed to identify semantic content. Electronic content may be parsed to identify one or more attributes corresponding to semantic data. The semantic data may be extracted from the electronic content. The semantic content corresponding to the semantic data may be stored 308 in semantic content storage 222.

### Overview of Client System

FIG. 4 shows a block diagram of client system 122 according to an embodiment of the present invention. Client system 122 may be a user-operated computing device that may be implemented using hardware, firmware, software, or combinations thereof to interact with UPP system 102. For example, client system 122 may be a client device, including, without limitation, a desktop computer, a laptop computer, a tablet computer, a smart phone, a wearable computing device, a personal digital assistant, and so on. Client system 122 may be implemented as a client accessing a service and/or application provided by UPP system 102. In some embodiments, client system 122 may be implemented as part of UPP system 102 for operation of UPP system 102 to perform operations as described in the foregoing disclosure.

Client system 122 may include interface 410. Interface 410 may include a physical interface, a graphical interface (e.g., a graphical user interface), or a combination thereof. A graphical interface of interface 410 may be generated by client system 122, received from UPP system 102, or a combination thereof. Interface 410 may be provided by UPP system 102 via network 140 as part of a service (e.g., a cloud service) or application. In at least one example, an operator of UPP system 102 may operate client system 122 to interact with interface 410.

In some embodiments, interface 410 may provide a publishing editor interface 202 that may enable a user to provide input related to management of semantic content. Functions for managing semantic content may include editing semantic content, configuring a format of content data identified by semantic content, configuring a layout of content data identified by semantic content, or combinations thereof. The graphical interface described below with reference to FIG. 10 provides examples of features of a publishing editor interface 202. In some embodiments, publication editor interface 202 may provide access to functionality provided by one or more applications described below.

In some embodiments, client system 122 may provide access to one or more applications 420 (“app”). App 420 may enable a user to access and perform enhanced functions provided by UPP system 102 to manage publishing of content. A semantic content editor app 422 may enable a user to manage semantic content including, without limitation, functions such as editing semantic content, arranging semantic content, and adding semantic content. In another example, template editor app 424 may enable a user to manage one or more templates for displaying content data identified by semantic content. Template editor app 424 may provide functionality including, without limitation, selecting a template editing a template, creating a template, removing a template, and combining templates. Template editor app 424 may enable a user to define a layout of a template. The layout may be defined based on factors including a display configuration, a type of destination, an interface of a destination, type of semantic content, a type of publication, or other factors related to displaying semantic content. Template editor app 424 may provide an interface that enables a user to specify one or more factors for displaying semantic content. Template editor app 424 may provide one or more templates for selection based on the factors indicated by a user. In some embodiments, one or more apps 420 may provide functionality for features of publishing editor interface 202 described herein.

In some embodiments, app 420 may enable a user to indicate a type of semantic content to be displayed. The types of semantic content may include, without limitation, a subject matter, a title, an author, a publisher, or other types of information. App 420 may request UPP system 102 to display semantic content based on the type of semantic content indicated by a user. A configuration for displaying content data identified by semantic content may be specified through one or more apps 420 described above.

App 420 may be implemented by one or more application modules. In some embodiments, all or part of the modules of app 420 may be stored and executed locally on client system 122 to operate app 420. For example, all or part of the modules of app 420 may be installed with client system 420 or may be stored after receipt from a computing system, e.g., UPP system 102, accessible to client system 122. In some embodiments, all or part of the modules of app 420 may be hosted and executed remotely on a computing system, e.g., UPP system 102, accessible to client system 122. App 420 may be implemented as a client app executing on an operating system of client system 122, a web browser that interfaces with a web-based messaging service, a service-specific application provided by UPP system 102, or another app. For example, app 420 may be implemented by UPP system 102 and accessed from client system 122 via interface 410. In some embodiments, access to use app 420 may be provided as a service by UPP system 102.

Client system 122 may implement a communication interface, such as communication interface 402 that includes functional blocks or modules, each of which may be configured to handle communications for client system 122, e.g., communications with UPP system 102. For example, communication interface 402 may be configured to use an appropriate protocol for communication UPP system 102. Communication interface 402 may communicate with UPP system using a protocol (e.g., an API) supported by publishing interface 212. In some embodiments, communication interface 402 may implement other interfaces, such as a network interface, web interface, or other remote communication interface, to enable app 420 to communicate with UPP system 102.

### Client System—Content Workflow

Client system 122 may include content workflow system 204. Content workflow system 204 may be implemented by functional systems or modules including third party content system 432, print publishing workflow system 434, UPP authoring system 436, and PDF extraction system 438.

Third party content system 432 may communicate with a third party CMS to receive and store electronic content for publishing. The electronic content received from third party content system 432 may be provided to UPP system 102 for display at one or more destinations 240. The electronic content may include semantic data identifying content data in the electronic content. In some embodiments, the electronic content received from a third party content system may include style format data for displaying content.

Print publishing workflow system 434 may generate electronic content that is based on a print publication such as newspapers, periodicals, or any other printed publication. The electronic content generated by print publishing workflow system 434 may be generated using a print workflow. The electronic content produced in this manner may have style format data for displaying the electronic content according to a print layout. Print publishing workflow system 434 may communicate with a third party publishing system to receive content having a print publication format.

UPP authoring system 436 may provide functionality to enable a user of client system 122 to author (e.g., create, edit, or delete) new electronic content. In some embodiments, access to UPP authoring system 436 may be provided through one of Apps 420. An interface 410 may be provided for an App 420 that enables a user to provide content data to author electronic content. Electronic content produced by UPP authoring system 436 may sent by client system 122 to UPP system 102 for display at one or more destinations 240.

Extraction system 438 may perform operation to extract content from electronic content. Electronic content may be accessed from many different sources including a CMS. Content may be extracted for publication to one or more destinations. In some embodiments, extraction system 438 may perform extraction on electronic content having a PDF format

Client system 122 may include content management store 404 to store content. Content may include content data and semantic data identifying content data. Content management store 404 may be a database or other data store that provides storage and retrieval of content data. Such content data may be stored before being sent to UPP system 102. Content management store 404 may store electronic content (e.g., electronic content 206) that is produced by a content publisher and/or received from one or more sources. For example, content data produced by content workflow system 204 may be stored in content management store 404.

### Examples of Formatted Electronic Content

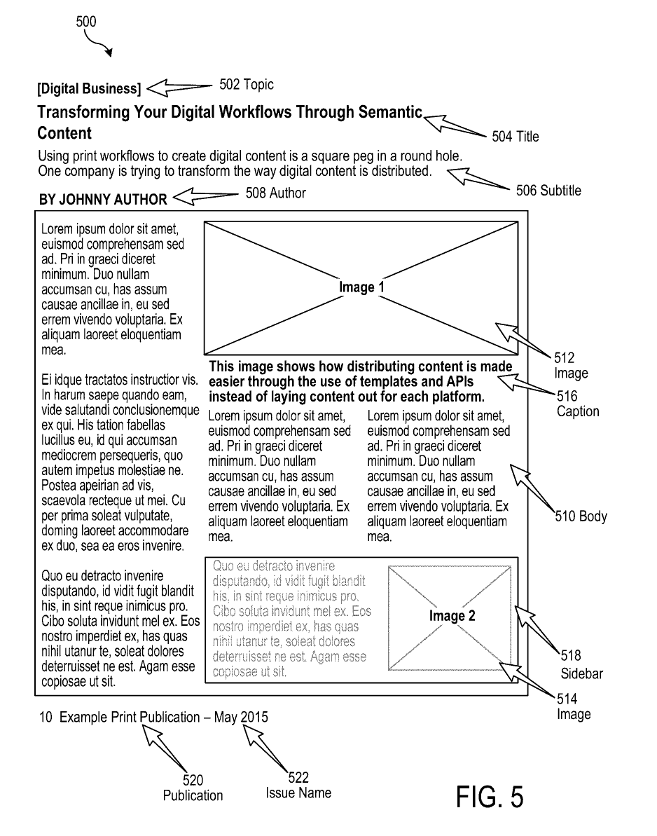

FIG. 5 illustrates an example of electronic content 500 having a format for displaying content data according to some embodiments of the present invention. Electronic content 500 may be electronic content 206 of FIG. 2. Electronic content 500 may be defined by data corresponding to an unstructured format, a structured format, or a combination thereof. The data may include text and/or images. The example of FIG. 5 shows electronic content 500 of a print publication in a PDF format. In this example, electronic content 500 includes text in a language (e.g., Spanish), and multiple images (e.g., image 1 and image 2). The format of electronic content 500 may be defined by a style format, e.g., how electronic content will appear when displayed, as shown in FIG. 5. Examples of formats may include, without limitation, PDF, HTML, extended markup language (XML), other display formats, or combinations thereof. For example, electronic content 500 includes style format data that indicates a style format of PDF for displaying the semantic content in electronic content 500. Electronic content 500 may be generated using one or more Web technologies, such as JavaScript, CSS, or other types of markup languages (e.g., HTML). Style format data in electronic content may introduce challenges to identifying content data in the electronic content. Specifically, semantic data that identifies the content data may be difficult to identify. Unless the style format is removed, the electronic content may be difficult to modify for a format supported by one of a plurality of destinations.

For purposes of illustration, electronic content 500 is shown including style format data corresponding to a PDF format; however, electronic content 500 may be implemented using other formatting techniques that are different from the format of electronic content 500 shown in FIG. 5. In the example of FIG. 5, content data may be arranged within style format data supporting a PDF format. Content data in electronic content 500 may include content such as a topic 502 (e.g., a category or a theme), a title 504, a subtitle 506, an author 508, a body 510, image 512 (“image 1”) and image 514 (“image 2”), one or more captions accompanying an image (e.g., caption 516), a sidebar 518, publication information 520, and issue information 522. Techniques described herein according to some embodiments of the invention may enable semantic data identifying content data to be extracted from electronic content that has style format data. The semantic data may be used in many ways, such as for aggregation of content data and presentation of the content data at different destinations that may have different display configurations.

In some embodiments, all or some of data in electronic content 500 may be received through an interface (e.g., publishing interface 212) and may be combined to form electronic content 500. Data in electronic content 500 may be stored using one or a combination of many types of data structures including, without limitation, an array, a record, a relational database table, a hash table, a linked list, or other types of data structures.

In FIG. 5, electronic content 500 may be defined using a style format data. For example, electronic content 500 having a style format of HTML may be formatted by attributes (e.g., style format data) in tags such as a pair of HTML tags tags (e.g., “<html>” and “</html>”), a pair of body tags 504 (e.g., “<body>” and “</body>”), a pair of div tags (e.g., “<div>” and “</div>”), one or more span tag(s) (e.g., “<span>”), and a pair of paragraph tags (e.g., “<p>” and “</p>”). One or more of the tags may include style format data such as attributes that indicate a style for displaying content data associated with the tag(s).

The style format data may define a format for displaying content data in electronic content 500. The semantic content may be arranged in a format based on the order, relationship, and/or arrangement of the format data. Electronic content 500 may be generated in a variety of ways, or as discussed above, may provide data in electronic content 500 through an interface. The style format associated with content data electronic content 500 may correspond to a layout (e.g., an editorial layout) for publishing electronic content.

UPP system 102 may process electronic content 500 to remove format data or alternatively, may extract semantic data from electronic content 500. Now turning to FIG. 6, an example of a data record in a semantic data store that stores semantic data extracted from electronic content 500 is shown according to some embodiments of the present invention. The data extracted from electronic content 500 may be produced by techniques described herein of processing performed by UPP system 102 to identify and extract style format data.

### Examples of Semantic Data Extracted and Managed by UPP System

FIG. 6 illustrates an example of a data record 600 in a semantic data store according to some embodiments of the present invention. A semantic data store may store semantic data identifying content data in electronic content. The content data may include one or more content items. Semantic data may have been extracted from electronic content or may be received through publishing interface 212. For example, the data in data record 600 may have been extracted from electronic content 500.

In some embodiments, semantic data may be stored in a semantic data store based on input received through publishing interface 212. The semantic data store may be included in or implemented as semantic content storage 222 of FIG. 2. In the examples described below, the content data identified by semantic data may be stored in the semantic data store or may be referenced in a different data store (e.g., content storage 218). In some embodiments, semantic data in data record 600 may be received from one or more sources, including client system 122 and extraction handler 238. The semantic data may include one or more attributes that define semantic content. In the example shown in FIG. 6, semantic data in data record 600 may be extracted from electronic content 500 received from one or more sources. As described above, electronic content received from a source, such as client system 122, may include style format data. Semantic data may be included in electronic content 500 to aid in the identification of content data stored in data record 600.

A semantic data store may be implemented as one or a combination of different types of data structures including, without restriction, an array, a record, a relational database table, a hash table, a linked list, or other types of data structures. A semantic data store may store a plurality of data records, each record including content data identified in electronic content by a plurality of attributes of semantic data. For purposes of illustration, data record 600 is shown organized with a particular number of fields (e.g., fields 602-610), each of which corresponding to one or more attributes of semantic data; however, a data record in a semantic data store may be defined by more or fewer fields in different arrangement than shown. The number and/or types of fields may vary based on a type of content and/or one or more attributes of semantic data identifying content. The data shown with respect to a particular field may be stored in data record 600 or may indicate a memory location where the data is located.

Electronic content may be produced by UPP system 102 after processing electronic 500 to remove a plurality of attributes indicating style in style format data of electronic content 500. Fields 602-610 in data record 600 may be identified from attributes of semantic data remaining the electronic content extracted from electronic content 500. The resulting electronic content after processing electronic content 500 is divorced from style format data that indicates a style for displaying content data.

UPP system 102 may transform the semantic content into electronic content having a format based on factors such as a desired layout and display configuration of a destination for displaying the semantic content. More specific example of electronic content including semantic content are described below with reference to FIGS. 10-13.

FIG. 6 shows an example content data in data record 600. Field 602 (“Title”) indicates content data corresponding to a title attribute identified in electronic content 500. Field 604 (“Subtitle”) indicates content data corresponding to a subtitle attribute identified in the electronic content 500. Field 606 (“Author”) indicates content data corresponding to an author attribute identified in electronic content 500. Field 608 (“Topic”) indicates content data corresponding to a topic attribute identified in electronic content 500. Field 610 (“Body”) indicates content data corresponding to a body attribute identified in electronic content 500.

Now turning to FIG. 7, an example of contents of a semantic data store 710 is illustrated according to some embodiments of the present invention. Semantic data store 710 may store semantic data identifying content data in electronic content. The content data may include one or more content items. Semantic may have been extracted from electronic content or may be received through publishing interface 212. In some embodiments, semantic data may be stored in semantic data store based on input received through publishing interface 212. Semantic data store 710 may be included in or implemented as semantic content storage 222 of FIG. 2. In the examples described below, the content data identified by semantic data may be stored in semantic data store 710 or may be referenced in a different data store (e.g., content storage 218).

Semantic data store 710 may be implemented as one or a combination of different types of data structures including, without restriction, an array, a record, a relational database table, a hash table, a linked list, or other types of data structures. For purposes of illustration, semantic data store 710 is shown organized with a particular number of fields (e.g., fields 712-720); however, semantic data store 710 may be defined by more or fewer fields in different arrangement than shown. The number and/or types of fields may vary based on a type of content and/or one or more attributes of semantic data identifying content. In the example shown in FIG. 7, the fields correspond to categories of content identified in content about golf. Data shown with respect to a particular field may identify content data including one or more content items. The data shown with respect to a particular field may be stored in semantic data store 710 or may indicate a memory location where the data is located.

FIG. 7 illustrates semantic data defining content data. UPP system 102 may identify semantic data in content data of electronic content based on attribute(s) of semantic data. Semantic data may be defined using a semantic language, such as semantic HTML or some other markup language that can be identified in formatted content data. A semantic language such as semantic HTML may be used to define semantic content or indicate a relationship (e.g., group) between semantic content. For example, tags of semantic HTML, such as a pair of divs tags (“<div>,</div>”) or a “<span>” tag may be used to define semantic content and/or distinguish a content item from other content items. Each different instance of a type of tag may represent an attribute or may include an attribute of data defining semantic content.

In the example shown in FIG. 6, semantic data in data record 600 is extracted from electronic content 500 based on one or more attributes. An attribute in content data may be used to distinguish content data for electronic content corresponding to one article from semantic content corresponding to other electronic content (e.g., articles) identified by semantic data in semantic content storage 222. Semantic data extracted from electronic content 500 may include one or more pairs of tags that identify content data in electronic content 500.

Field 712 indicates a value of an identifier of an electronic content (“electronic content identifier(s)”). Field 714 (“Title”) indicates content data corresponding to a title attribute identified in the electronic content identified by field 712. Field 716 (“Body”) indicates content data corresponding to a body attribute identified in electronic content identified by field 712. Field 718 (“Author”) indicates content data corresponding to an author attribute identified in electronic content identified by field 712. Field 720 (“Image Caption”) indicates content data corresponding to an image caption attribute identified in electronic content identified by field 712.

Semantic data store 710 may store a plurality of records, each record including content data identified in electronic content by a plurality of attributes (e.g., field 714-720) of semantic data. In a first example, record 730 may correspond to electronic content identifier 1. Record 730 may include content data having values including “Ian Poulter's Comeback,” “Ian Poulter achieved a seemingly sure victory in the Honda Classic two weeks ago,” “Author 1,” and “Ian Poulter celebration,” corresponding to fields 714, 716, 718, and 720, respectively. In a second example, record 740 may correspond to electronic content identifier 2. Record 740 may include content data having values including “Ian Poulter Win's again,” “Ian Poulter Wins again at a State classic,” “Author 2,” and “Ian Poulter final putt,” corresponding to fields 714, 716, 718, and 720, respectively. In a third example, record 750 may correspond to electronic content identifier 3. Record 750 may include content data having values including “Justin Rose unforgettable season,” “Justin Rose is a likely contender for the upcoming Master's tournament,” “Author 3,” and “Justin Rose press conference,” corresponding to fields 714, 716, 718, and 720, respectively.

In some embodiments, semantic data store 710 may be used to locate specific content data based on one or more attributes indicated by semantic data. The content data may be identified as being related or associated with a group based on one or more attributes. For example, semantic data store 710 may be used to identify content data for a title having a specific subject, such as one or more words (e.g., “Ian Poulter”). Semantic data store 710 may aggregate content data from multiple records in semantic data store 710 that are identified using one or more attributes of the semantic data. In the previous example, content data corresponding to each of records 730 and 740 may be aggregated because each record has a title with “Ian Pouler”). The aggregated content data may be combined to generate electronic content having a format for display at one or more destinations.

A semantic data store such as the one depicted in FIG. 7 provides many advantages to those publishing content including, but not limited to, content producers and content publishers. First, a semantic data store enables content data to be easily queried and retrieved based on semantic attributes identifying content data in an electronic content item. The content data may then be used to product electronic content that has a format suitable for display at different destinations. By storing semantic data in a semantic data store, one or more attributes of the semantic data may be used to identify specific content items in content data. The content data identified in a semantic data store may be aggregated to identify content data in multiple items of electronic content, thereby enabling a content producer to produce new electronic content without having to search and retrieve content data from previously generated electronic content. This ability enables content producers to reduce processing time for developing a content workflow to produce new and different combinations of electronic content for distribution to multiple destinations.

### Content Transformation Process in UPP System

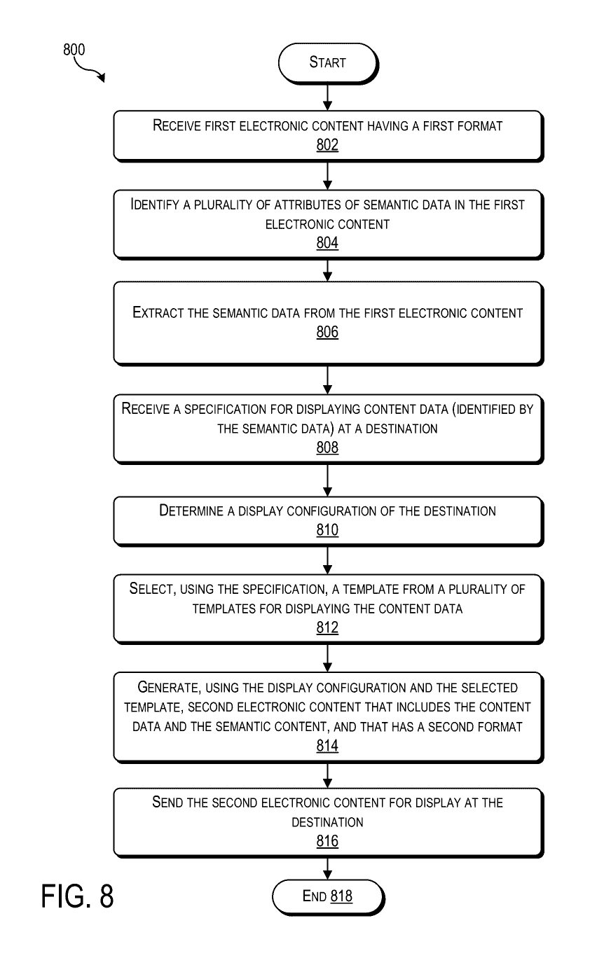

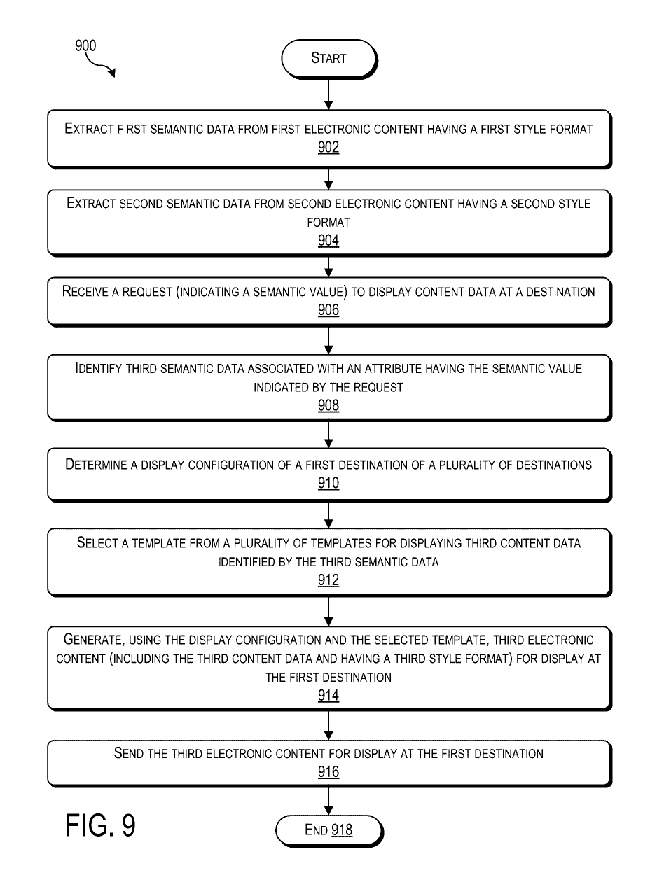

FIGS. 8 and 9 provide flowcharts illustrating processes for transforming electronic content for display at a destination according to some embodiments of the present invention. Individual embodiments may be described as a process which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

The processes depicted in FIGS. 8 and 9 may be implemented in software (e.g., code, instructions, program) executed by one or more processing units (e.g., processors cores), hardware, or combinations thereof. The software may be stored in a memory (e.g., on a memory device, on a non-transitory computer-readable storage medium). The particular series of processing steps in FIGS. 8 and 9 is not intended to be limiting. Other sequences of steps may also be performed according to alternative embodiments. For example, alternative embodiments of the present invention may perform the steps outlined above in a different order. Moreover, the individual steps illustrated in FIGS. 8 and 9 may include multiple sub-steps that may be performed in various sequences as appropriate to the individual step. Furthermore, additional steps may be added or removed depending on the particular applications. While processing depicted in FIG. 8 is with respect to electronic content, such processing may be performed for several items of electronic content (e.g., multiple articles, each including electronic content). While processing depicted in FIG. 9 is with respect to two different items of electronic content, the processing may be performed for several items of electronic content, each of which may be processed to identify semantic content that identifies content data. The identified content data may be aggregated to produce electronic content including the aggregated content data for display at one or more destinations. One of ordinary skill in the art would recognize many variations, modifications, and alternatives.

Now turning to FIG. 8, flowchart 800 is shown illustrating a process for transforming electronic content for display at a destination according to some embodiments of the present invention. In some embodiments, the process depicted in FIG. 8 may be implemented using UPP system 102 of FIGS. 1-3. The process illustrated by FIG. 8 includes processing electronic content (e.g., an article having a formatted content layout) to transform content data in the electronic content for display at one or more of a variety of destinations. Those destinations may include any one of destinations 240 of FIG. 2. This process may determine a format for displaying the content data based on a specification (e.g., obtained from a user, such as a publisher). The process may generate electronic content in a format enabling content data identified by semantic data to be displayed according to the specification. The electronic content may be generated based on consideration of one or more factors. One factor may include a configuration of the destination (e.g., size of display, type of device, an interface of the destination). Another factor may include an application (e.g., a blog, a social media application, or a web browser) at the destination in which the generated electronic content will be displayed. Another factor may include a configuration of a system at the destination that will use the generated electronic content to display the content at the destination.

Flowchart 800 begins at step 802 in which electronic content (e.g., “first electronic content”) having a format (e.g., a “first format”) is received. The format may have a style (e.g., a “first style”) for displaying the first electronic content. For example, electronic content 206 may be received by UPP system 102 from client system 122 (e.g., “client publisher system”).

At step 804, a plurality of attributes of semantic data in the first electronic content are identified. Examples of a plurality of attributes include, without limitation, a title of electronic content, a subtitle of electronic content, an author of electronic content, a body of electronic content, one or more images, one or more captions, publication information, issue information, and a sidebar. The semantic data may identify content data in the first electronic content. In at least one embodiment, a plurality of attributes may be identified by parsing the first electronic content based on the format. For example, when the format of the first electronic content is based on HTML, the HTML may be parsed to identify style format data (e.g., HTML) associated with the first style of the format. Based on identifying the style format data, other data (e.g., semantic data) that defines the meaning of the electronic content may be identified as not being a part of the style format data. Semantic data may be in a format such as semantic HTML. The semantic data may be identified by parsing the electronic content. The semantic data may not be included in the format of the electronic content. As such, the semantic data may be identified by parsing the style format data. The semantic data may correspond to one or more attributes having values that define semantic content in the electronic content.

Semantic data corresponding to a plurality of attributes in the first electronic content may be extracted from the first electronic content at step 806. The semantic data may be that which was identified at step 804. The semantic data may be extracted based on the first format of the first electronic content. In at least one embodiment, the semantic data may be extracted by: 1) identifying style format data of the first format in the first electronic content, the style format data including one or more style attributes defining the first style; and parsing, using the identified style format data, the first electronic content to identify each of the plurality of attributes. The style format data may have been identified at step 804 to identify the plurality of attributes. In some embodiments, the semantic data may be parsed to identify a value for the semantic data corresponding to each of the plurality of attributes. The value corresponding to the semantic data for each of the plurality of attributes may be extracted from the first electronic content.

At step 808, a specification for displaying content data at a destination may be received. The content data may be identified based on the semantic data extracted from the first electronic content at step 806. Examples of destinations may include those described for destinations 240. The specification may include data that indicates an arrangement for displaying the content data identified by one or more of a plurality of attributes identified at step 804. An arrangement for displaying the content data may include a format, a layout, an appearance (e.g., a look and feel), other display attributes for displaying the content data, or combinations thereof. In some embodiments, the specification may indicate a style format for displaying the semantic data. For example, the specification may be received through publishing interface 212 from client system 122. Client system 122 may receive the specification through a graphical interface, e.g., publishing editor interface, which enables a user to provide input for the specification. FIG. 10 provides at least one example of a graphical interface for configuring semantic data.

A display configuration of a destination (e.g., one of destinations 240) is determined at step 810 for displaying the content data. The display configuration of the destination may be determined by requesting the display configuration from the destination. In some embodiments, the display configuration may be obtained from a data store (e.g., destination configurations), which includes information about a display configuration of the destination. The data store may be queried to determine a display configuration based on the type of destination. A display configuration may be defined based on an interface (e.g., an API) that indicates one or more display attributes for displaying content data at the destination.

A display configuration may include one or more attributes of a display device (e.g., a display device on a mobile phone) associated with the destination. When a destination is an application (e.g., a Web application or a social media application), a display configuration may include one or more display attributes for displaying electronic content in the application. For example, a display configuration of an application may include one or more input fields corresponding to an interface (e.g., an API) of the application.

Using a specification (e.g., the specification received at step 808), a template may be selected, at step 812, from a plurality of templates for displaying content data identified by the semantic data extracted at step 806. As discussed above, a specification may indicate a desired layout for presenting content data. The specification may be used to select a layout defined by one of the plurality of templates. In some embodiments, each of the plurality of templates defines a different editorial layout for displaying the content data. A template may be created using a number of different Web technologies including HTML, CSS, and Javascript.

In at least one embodiment, a template may be selected based on the first format of the first electronic content that is received at step 812. The first format may indicate a layout for displaying the content data. In some instances, the layout indicated by the first format may not be properly displayed at a destination due to a display configuration of the destination. As such, the layout may be used to select a template that defines a corresponding layout for display of the content data at a destination. In at least one embodiment, a template may be selected, using a display configuration of the destination, from the plurality of templates. Although a specification may indicate a preferred layout, such a layout may not be properly displayed for the desired destination. A template may be selected based on consideration of a display configuration to display content data in a layout supported by the destination. The layout may preserve features or elements of the layout indicated by the specification.

At 814, electronic content (e.g., “second electronic content”) may be generated using a display configuration and a selected template (e.g., a template selected at step 812). The second electronic content may include semantic data (e.g., the semantic data extracted at step 806) and content data identified by the semantic data. The second electronic content may have a second format, which has a style (e.g., a “second style”) for displaying the second electronic content. In some embodiments, the second format may be different from the first format of the first electronic content received at step 802. As explained above, a template may indicate a layout for displaying the content data. A template may be used to generate electronic content to a format defined by the template.

In some embodiments, a template may define a layout that may be used to generate electronic content for display at different types of destinations. In such embodiments, different types of destinations may have different display configurations. Electronic content may have a different format to display content data at different types of destinations based on a selected template. In such cases, the second electronic content may be generated based on the display configuration of the destination in addition to the selected template.

The electronic content generated at step 814 may be sent for display at a destination, at 816. The electronic content may be transmitted directly to a destination, such as a mobile device. In some embodiments, electronic content may be sent based on a type of the destination to display the electronic content. Flowchart 800 may end at step 818.

### Content Aggregation and Transformation Process in UPP System

In FIG. 9, flowchart 900 is shown illustrating a process for transforming electronic content for display at a destination according to some embodiments of the present invention. In some embodiments, the process depicted in FIG. 9 may be implemented using UPP system 102 of FIGS. 1-3.

In some embodiments, the process illustrated by FIG. 9 may extract semantic data from different electronic content (e.g., different publications having the same or different formats) received from one or more content sources. A content source may be produced by a content producer. The extracted semantic data may be stored in a semantic data store with semantic data extracted from other electronic content items. The content producer may request that all or some of the semantic data in the semantic data store be displayed at a destination. For example, the request may indicate one or more attributes of semantic data (e.g., a subject of content or a type of content), based on which, semantic data matching the attribute(s) in the request is retrieved from the semantic data store. The request may indicate a specification for displaying content data identified by the semantic data. Based on a display configuration of the destination, the semantic data retrieved from the data store may be formatted in electronic content based on the template and the display configuration. The electronic content may be sent to the destination. The techniques described for the process shown by flowchart 900 may enable a content producer to aggregate content data from multiple sources (e.g., publications) and then customize the aggregated content data for display at multiple different destinations based on a desired template for publication. The aggregated content data may be adjusted for display based on a configuration of the destination.

Flowchart 900 may begin at step 902, where first semantic data may be extracted from first electronic content having a first style format. The first semantic data may correspond to a first plurality of attributes that define first content data in the first electronic content. At step 904, second semantic data may be extracted from second electronic content having a second style format. The second semantic data may correspond to a second plurality of attributes that define second content data in the second electronic content.

In some embodiments, the first content data may be stored to a semantic data store in association with the first plurality of attributes. The second content data may be stored to the semantic data store in association with the second plurality of attributes. One or more of the plurality of attributes may be similar or identical to one or more of the second plurality of attributes.

A request to display content data may be received at step 906. The request may indicate a specification for displaying content data. For example, the specification may be received through publishing interface 212 from client system 122. Client system 122 may receive the specification through a graphical interface, which enables a user to provide input for the specification. The request may indicate a value that identifies the semantic content. Examples of values may include, without limitation, a subject matter, an author, a title, a subtitle, a keyword, an image, other information identifying an attribute of semantic content, or combinations thereof.

At step 908, semantic data (e.g., “third semantic data”) associated with an attribute having a value indicated by a request may be identified. The value may be indicated by the request received at step 906. The third semantic data may be identified based in part on the first semantic data and the second semantic data. A semantic data store may be searched to identify the third semantic data associated with one or more attributes having the value indicated by the request. The third semantic data may include the first semantic data and the second semantic data corresponding to the attribute having the value.

A display configuration of a destination (e.g., a “first destination”) of a plurality of destinations may be determined at step 910. As discussed above, a display configuration of a destination may be determined by requesting the display configuration from the destination or may be obtained from a data store (e.g., destination configurations), which includes information about a display configuration of the destination.

At step 912, a template may be selected from a plurality of templates for displaying the third content data identified by the third semantic data. The template may be selected using the specification received in a request at step 906.

At step 914, electronic content (e.g., “third electronic content”) may be generated for display at the first destination using the display configuration of the first destination and the selected template. The third electronic content may include the third content data. The third electronic content may have a style format (e.g., a “third style format”) for displaying the third content data. The third electronic content may be sent, at step 916, for display at the first destination. Process 900 may end at 918.

### Content Editor Interface for Accessing UPP System

FIG. 10 illustrates a graphical interface 1000 to configure semantic data for publishing according to some embodiments of the present invention. Graphical interface 1000 may be generated by UPP system 102 and provided to client system 122 for display at interface 410. Graphical interface 1000 may be displayed in an application (e.g., app 420).

In the example of FIG. 10, graphical interface 1000 may display content data identified by semantic data 1000. For example, a body of content 1010 is displayed for a body attribute corresponding to field 610 of data record 600 containing semantic data extracted from electronic content 600. A title 1002 is displayed for a title attribute corresponding to field 602 in data record 600. A subtitle 1004 is displayed for a subtitle attribute corresponding to field 604 of data record 600. A topic 1008 is displayed for a topic attribute corresponding to field 608 of data record 600. An image 1016 is displayed for an image extracted from electronic content 500. Multiple figures and their corresponding captions may be displayed for images 1016.

In some embodiments, graphical interface 1000 may include one or more interactive elements, e.g., an interactive element 1012, to enable a user to identify and modify semantic attributes in semantic data extracted from electronic content 500. An example of interactive element 1012 may be a toolbar of interactive controls. Interactive element 1012 may receive input to add and/or remove semantic content, such as text, an image, or video associated with an attribute. Semantic data 1000 may be displayed in graphical interface 1000 in association with one or more interactive elements to enable the semantic content or one or more of attributes of semantic data to be identified. Based on a configuration of semantic data using graphical interface 1000, client system 122 displaying graphical interface 1000 may send the attributes of the semantic data to UPP system 102 for storage in semantic content storage 222.

In some embodiments, graphical interface 1000 may include an interactive element 1018 to enable the semantic data to be previewed for displaying at one or more types of destinations (e.g., a mobile device or an application). Interaction with interactive element 1018 may cause another graphical interface to be displayed with the semantic data displayed based on a template and a display configuration of a destination.

In some embodiments, a graphical interface may be provided that enables a user to manage (e.g., create, read, update, or delete) templates. The graphical interface may provide one or more interactive elements to enable a user to provide input to specify a template for determining a layout to display semantic content. Graphical interface 1000 may display one or more templates for displaying semantic content. The template(s) may be presented for selection based on a destination for displaying semantic content. In some embodiments, graphical interface 1000 may enable a user to configure one or more templates for displaying semantic content. The template(s) may be presented for selection based on input received from a user, such as a type of publication or audience for viewing semantic content.

### Examples of Content Transformation by UPP System for Various Destinations

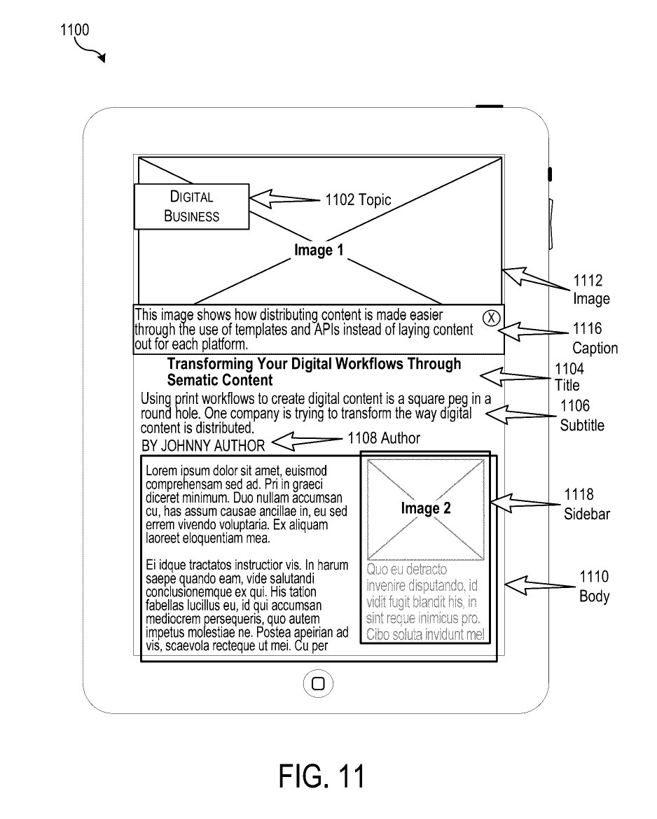

FIGS. 11-13 illustrate various graphical interfaces displaying examples of content data displayed at different destinations according to some embodiments of the present invention. Each graphical interface shown in FIGS. 11-13 may be generated by UPP system 102 and sent to a destination for display at the destination. In each of the examples, semantic data corresponding to attributes such as the title, the subtitle, the images and accompanying captions, the sidebar, and the body are mapped to different locations in graphical interface 1100 compared to electronic content 500 shown in a print publication.

In one example, FIG. 11 illustrates a graphical interface 1100 for displaying content data based on a configuration for publishing content according to some embodiments of the present invention. Graphical interface 1100 is an example of content data displayed at a destination (e.g., an application in a tablet device) based on semantic data extracted from electronic content 500. This example shows how content data identified by semantic data is mapped for display at a particular destination. A template may be selected for displaying the content data. The template may be chosen for a desire content layout for the destination. Based on the template, semantic data may be used to map content data for display at graphical interface 1100 of a destination.

In this example, topic 502 of FIG. 5 is mapped to topic 1102 in graphical interface 1100. Title 504 and subtitle 506 are mapped to title 1104 and subtitle 1106, respectively, in graphical interface 1100. The figures and captions identified by image 512 and caption 516 are mapped to image 1112 and caption 1116, respectively, in graphical interface 1100. Images may be shown in various positions in the layout of graphical interface 1100. Sidebar 518 is mapped to sidebar 1118.

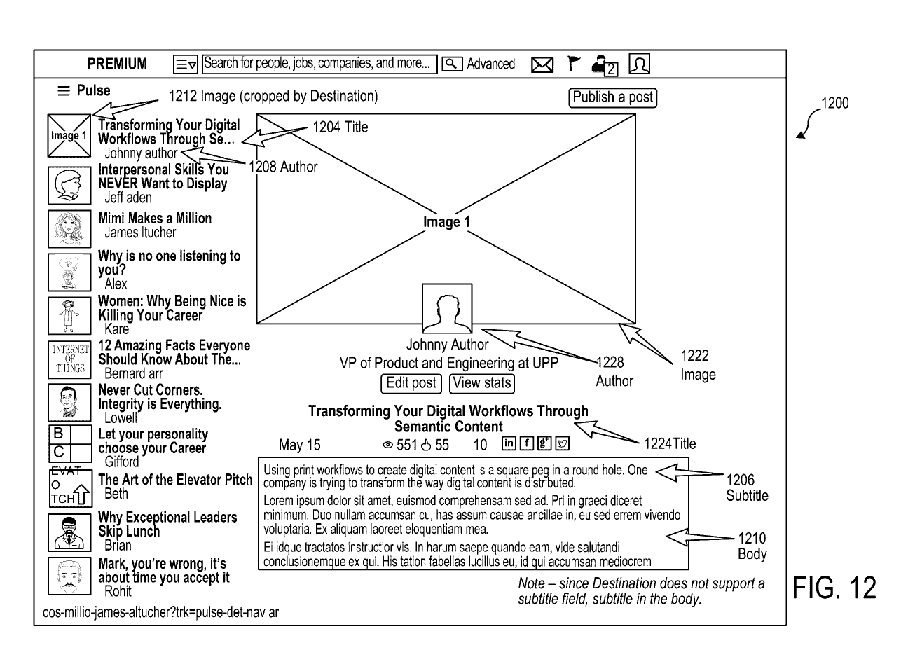

In another example, FIG. 12 illustrates a graphical interface 1200 for displaying content data based on a configuration for publishing content according to some embodiments of the present invention. Graphical interface 1200 is an example of content data displayed at a destination (e.g., a third party social media website) based on semantic data extracted from electronic content 500. In some embodiments, the semantic data may be provided to a destination operated by a third party to display the semantic data in a format. The semantic data may be communicated to the third party through an interface (e.g., an application programming interface) provided by the third party. The attributes associated with the semantic data may be helpful to identify the different semantic data to be provided through the interface.

In this example, image 512, title 504, and author 508 have been mapped to multiple locations in graphical interface 1200. For example, image 512, title 504, and author 508 have been mapped to image 1212, title 1204, and author 1208, respectively in a side portion of graphical interface 1200 whether other content is identified. Image 512, title 504, and author 508 have also been mapped to image 1222, title 1224, and author 1228, respectively, in the display of semantic data including body 1210 and subtitle 1206. However, subtitle 506 and body 510 have been mapped to subtitle 1206 and body 1210, respectively, together because this destination may not support displaying content corresponding to some types of attributes of semantic data. The attributes of the semantic data enables the semantic data to be grouped for display as needed since the semantic data is separated from style format data.

In the example shown in FIG. 12, graphical interface 1200 lays out content data in a different layout than graphical interface 1100. The layout may be selected based on the destination displaying the content data. The content data may be displayed based on a template selected for displaying content at a third party website. The layout of content data may be different because of the display configuration of the destination. In this example, since there is more visible display area to show content, content data may be formatted differently than the example in FIG. 11, which may be displayed by an application on a device with a smaller screen size. Since the content data is without formatting, the content data may be easily placed into a layout determined for a specific destination.

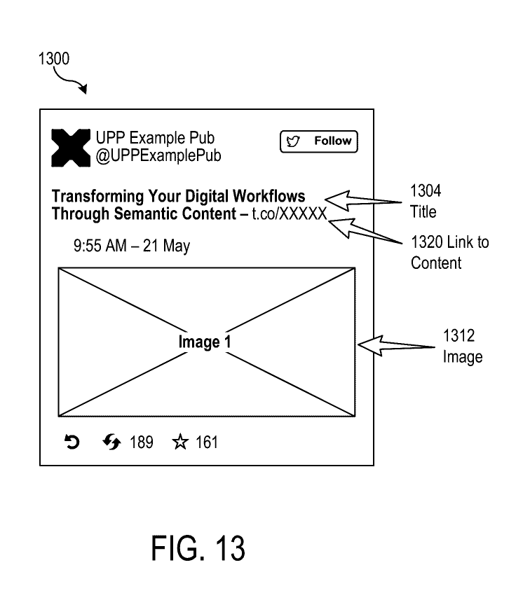

In yet another example, FIG. 13 illustrates a graphical interface 1300 for displaying content data based on a configuration for publishing content according to some embodiments of the present invention. Graphical interface 1300 is an example of content data displayed at a destination (e.g., an application) based on semantic data extracted from electronic content 500. This example shows how content data identified by semantic data is mapped for display at a particular destination. A template may be selected for displaying the content data. The template may be chosen for a desire content layout for the destination. Based on the template, semantic data may be used to map content data for display at graphical interface 1300 of a destination.

In this example, title 504 of FIG. 5 is mapped to title 1304, and image 512 is mapped to image 1312 in graphical interface 1300. In this example, a portion of semantic data is shown in graphical interface 1300, while the remainder is published at a website identified by a uniform resource locator (URL), e.g., a link, to content. For example, graphical interface 1300 shows link 1320 to semantic content displayed at a website.

### Computer Systems for UPP System and Client System

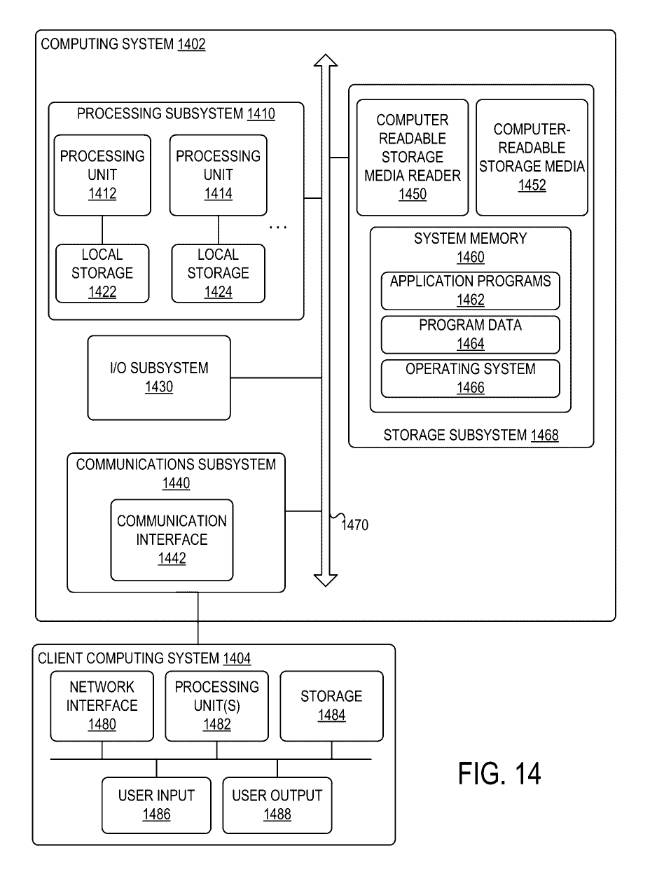

Various operations described herein may be implemented on computer systems, which may be of generally conventional design. FIG. 14 shows a simplified block diagram of a representative computing system 1402 and client computing system 1404 usable to implement certain embodiments of the present invention. In various embodiments, computing system 1402 or similar systems may implement UPP system 102, or any other computing system described herein or portions thereof. Client computing system 1404 or similar systems may implement client system 122, or other client systems described herein.

Computing system 1402 may be one of various types, including a handheld portable device (e.g., an iPhone® cellular phone, an iPad® computing tablet, a PDA), a wearable device (e.g., a Google Glass® head mounted display), a personal computer, a workstation, a mainframe, a kiosk, a server rack, or any other data processing system.

Computing system 1402 may include processing subsystem 1410. Processing subsystem 1410 may communicate with a number of peripheral systems via bus subsystem 1470. These peripheral systems may include I/O subsystem 1430, storage subsystem 1468, and communications subsystem 1440.

Bus subsystem 1470 provides a mechanism for letting the various components and subsystems of server computing system 1404 communicate with each other as intended. Although bus subsystem 1470 is shown schematically as a single bus, alternative embodiments of the bus subsystem may utilize multiple buses. Bus subsystem 1470 may form a local area network that supports communication in processing subsystem 1410 and other components of server computing system 1420. Bus subsystem 1470 may be implemented using various technologies including server racks, hubs, routers, etc. Bus subsystem 1470 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which may be implemented as a Mezzanine bus manufactured to the IEEE P1386.1 standard, and the like.

I/O subsystem 1430 may include devices and mechanisms for inputting information to computing system 1402 and/or for outputting information from or via computing system 1402. In general, use of the term “input device” is intended to include all possible types of devices and mechanisms for inputting information to computing system 1402. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Microsoft Kinect® motion sensor that enables users to control and interact with an input device, the Microsoft Xbox® 360 game controller, devices that provide an interface for receiving input using gestures and spoken commands. User interface input devices may also include eye gesture recognition devices such as the Google Glass® blink detector that detects eye activity (e.g., “blinking” while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Ski® navigator), through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computing system 1402 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Processing subsystem 1410 controls the operation of computing system 1402 and may comprise one or more processing units 1412, 1414, etc. A processing unit may include one or more processors, including single core processor or multicore processors, one or more cores of processors, or combinations thereof. In some embodiments, processing subsystem 1410 may include one or more special purpose co-processors such as graphics processors, digital signal processors (DSPs), or the like. In some embodiments, some or all of the processing units of processing subsystem 1410 may be implemented using customized circuits, such as application specific integrated circuits (ASICs), or field programmable gate arrays (FPGAs). In some embodiments, such integrated circuits execute instructions that are stored on the circuit itself. In other embodiments, processing unit(s) may execute instructions stored in local storage, e.g., local storage 1422, 1424. Any type of processors in any combination may be included in processing unit(s) 1412, 1414.

In some embodiments, processing subsystem 1410 may be implemented in a modular design that incorporates any number of modules (e.g., blades in a blade server implementation). Each module may include processing unit(s) and local storage. For example, processing subsystem 1410 may include processing unit 1412 and corresponding local storage 1422, and processing unit 1414 and corresponding local storage 1424.

Local storage 1422, 1424 may include volatile storage media (e.g., conventional DRAM, SRAM, SDRAM, or the like) and/or non-volatile storage media (e.g., magnetic or optical disk, flash memory, or the like). Storage media incorporated in local storage 1422, 1424 may be fixed, removable or upgradeable as desired. Local storage 1422, 1424 may be physically or logically divided into various subunits such as a system memory, a ROM, and a permanent storage device. The system memory may be a read-and-write memory device or a volatile read-and-write memory, such as dynamic random access memory. The system memory may store some or all of the instructions and data that processing unit(s) 1412, 1414 need at runtime. The ROM may store static data and instructions that are needed by processing unit(s) 1412, 1414. The permanent storage device may be a non-volatile read-and-write memory device that may store instructions and data even when a module including one or more processing units 1412, 1414 and local storage 1422, 1424 is powered down. The term “storage medium” as used herein includes any medium in which data may be stored indefinitely (subject to overwriting, electrical disturbance, power loss, or the like) and does not include carrier waves and transitory electronic signals propagating wirelessly or over wired connections.

In some embodiments, local storage 1422, 1424 may store one or more software programs to be executed by processing unit(s) 1412, 1414, such as an operating system and/or programs implementing various server functions such as functions of UPP system 102, or any other server(s) associated with UPP system 102. “Software” refers generally to sequences of instructions that, when executed by processing unit(s) 1412, 1414 cause computing system 1402 (or portions thereof) to perform various operations, thus defining one or more specific machine implementations that execute and perform the operations of the software programs. The instructions may be stored as firmware residing in read-only memory and/or program code stored in non-volatile storage media that may be read into volatile working memory for execution by processing unit(s) 1412, 1414. In some embodiments the instructions may be stored by storage subsystem 1468 (e.g., computer readable storage media). In various embodiments, the processing units may execute a variety of programs or code instructions and may maintain multiple concurrently executing programs or processes. At any given time, some or all of the program code to be executed may be resident in local storage 1422, 1424 and/or in storage subsystem including potentially on one or more storage devices. Software may be implemented as a single program or a collection of separate programs or program modules that interact as desired. From local storage 1422, 1424 (or non-local storage described below), processing unit(s) 1412, 1414 may retrieve program instructions to execute and data to process in order to execute various operations described above.

Storage subsystem 1468 provides a repository or data store for storing information that is used by computing system 1402. Storage subsystem 1468 provides a tangible non-transitory computer-readable storage medium for storing the basic programming and data constructs that provide the functionality of some embodiments. Software (programs, code modules, instructions) that when executed by processing subsystem 1410 provide the functionality described above may be stored in storage subsystem 1468. The software may be executed by one or more processing units of processing subsystem 1410. Storage subsystem 1468 may also provide a repository for storing data used in accordance with the present invention.

Storage subsystem 1468 may include one or more non-transitory memory devices, including volatile and non-volatile memory devices. As shown in FIG. 14, storage subsystem 1468 includes a system memory 1460 and a computer-readable storage media 1452. System memory 1460 may include a number of memories including a volatile main RAM for storage of instructions and data during program execution and a non-volatile ROM or flash memory in which fixed instructions are stored. In some implementations, a basic input/output system (BIOS), containing the basic routines that help to transfer information between elements within computing system 1402, such as during start-up, may typically be stored in the ROM. The RAM typically contains data and/or program modules that are presently being operated and executed by processing subsystem 1410. In some implementations, system memory 1460 may include multiple different types of memory, such as static random access memory (SRAM) or dynamic random access memory (DRAM). Storage subsystem 1468 may be based on magnetic, optical, semiconductor, or other data storage media. Direct attached storage, storage area networks, network-attached storage, and the like may be used. Any data stores or other collections of data described herein as being produced, consumed, or maintained by a service or server may be stored in storage subsystem 1468.

By way of example, and not limitation, as depicted in FIG. 14, system memory 1460 may store application programs 1462, which may include client applications, Web browsers, mid-tier applications, relational database management systems (RDBMS), etc., program data 1464, and one or more operating systems 1466. By way of example, an example operating systems may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® 10 OS, and Palm® OS operating systems.

Computer-readable storage media 1452 may store programming and data constructs that provide the functionality of some embodiments. Software (programs, code modules, instructions) that when executed by processing subsystem 1410 a processor provide the functionality described above may be stored in storage subsystem 1468. By way of example, computer-readable storage media 1452 may include non-volatile memory such as a hard disk drive, a magnetic disk drive, an optical disk drive such as a CD ROM, DVD, a Blu-Ray® disk, or other optical media. Computer-readable storage media 1452 may include, but is not limited to, Zip® drives, flash memory cards, universal serial bus (USB) flash drives, secure digital (SD) cards, DVD disks, digital video tape, and the like. Computer-readable storage media 1452 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. Computer-readable media 1452 may provide storage of computer-readable instructions, data structures, program modules, and other data for computing system 1402.

In certain embodiments, storage subsystem 1468 may also include a computer-readable storage media reader 1450 that may further be connected to computer-readable storage media 1452. Together and, optionally, in combination with system memory 1460, computer-readable storage media 1452 may comprehensively represent remote, local, fixed, and/or removable storage devices plus storage media for storing computer-readable information.

In certain embodiments, computing system 1402 may provide support for executing one or more virtual machines. Computing system 1402 may execute a program such as a hypervisor for facilitating the configuring and managing of the virtual machines. Each virtual machine may be allocated memory, compute (e.g., processors, cores), I/O, and networking resources. Each virtual machine typically runs its own operating system, which may be the same as or different from the operating systems executed by other virtual machines executed by computing system 1402. Accordingly, multiple operating systems may potentially be run concurrently by computing system 1402. Each virtual machine generally runs independently of the other virtual machines.

Communication subsystem 1440 provides an interface to other computer systems and networks. Communication subsystem 1440 serves as an interface for receiving data from and transmitting data to other systems from computing system 1402. For example, communication subsystem 1440 may enable computing system 1402 to establish a communication channel to one or more client computing devices via the Internet for receiving and sending information from and to the client computing devices.

Communication subsystem 1440 may support both wired and/or wireless communication protocols. For example, in certain embodiments, communication subsystem 1440 may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communication subsystem 1440 may provide wired network connectivity (e.g., Ethernet) in addition to or instead of a wireless interface.

Communication subsystem 1440 may receive and transmit data in various forms. For example, in some embodiments, communication subsystem 1440 may receive input communication in the form of structured and/or unstructured data feeds, event streams, event updates, and the like. For example, communication subsystem 1440 may be configured to receive (or send) data feeds in real-time from users of social media networks and/or other communication services such as Twitter® feeds, Facebook® updates, web feeds such as Rich Site Summary (RSS) feeds, and/or real-time updates from one or more third party information sources.

In certain embodiments, communication subsystem 1440 may be configured to receive data in the form of continuous data streams, which may include event streams of real-time events and/or event updates, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communication subsystem 1440 may also be configured to output the structured and/or unstructured data feeds, event streams, event updates, and the like to one or more databases that may be in communication with one or more streaming data source computers coupled to computing system 1402.

Communication subsystem 1440 may provide a communication interface 1442, e.g., a WAN interface, which may provide data communication capability between the local area network (bus subsystem 1470) and a larger network, such as the Internet. Conventional or other communications technologies may be used, including wired (e.g., Ethernet, IEEE 802.3 standards) and/or wireless technologies (e.g., Wi-Fi, IEEE 802.11 standards).

Computing system 1402 may operate in response to requests received via communication interface 1442. Further, in some embodiments, communication interface 1442 may connect computing systems 1402 to each other, providing scalable systems capable of managing high volumes of activity. Conventional or other techniques for managing server systems and server farms (collections of server systems that cooperate) may be used, including dynamic resource allocation and reallocation.

Computing system 1402 may interact with various user-owned or user-operated devices via a wide-area network such as the Internet. An example of a user-operated device is shown in FIG. 14 as client computing system 1402. Client computing system 1404 may be implemented, for example, as a consumer device such as a smart phone, other mobile phone, tablet computer, wearable computing device (e.g., smart watch, eyeglasses), desktop computer, laptop computer, and so on.

For example, client computing system 1404 may communicate with computing system 1402 via communication interface 1442. Client computing system 1404 may include conventional computer components such as processing unit(s) 1482, storage device 1484, network interface 1480, user input device 1486, and user output device 1488. Client computing system 1404 may be a computing device implemented in a variety of form factors, such as a desktop computer, laptop computer, tablet computer, smart phone, other mobile computing device, wearable computing device, or the like.

Processing unit(s) 1482 and storage device 1484 may be similar to processing unit(s) 1412, 1414 and local storage 1422, 1424 described above. Suitable devices may be selected based on the demands to be placed on client computing system 1404; for example, client computing system 1404 may be implemented as a “thin” client with limited processing capability or as a high-powered computing device. Client computing system 1404 may be provisioned with program code executable by processing unit(s) 1482 to enable various interactions with computing system 1402 of a message management service such as accessing messages, performing actions on messages, and other interactions described above. Some client computing systems 1404 may also interact with a messaging service independently of the message management service.

Network interface 1480 may provide a connection to a wide area network (e.g., the Internet) to which communication interface 1440 of computing system 1402 is also connected. In various embodiments, network interface 1480 may include a wired interface (e.g., Ethernet) and/or a wireless interface implementing various RF data communication standards such as Wi-Fi, Bluetooth, or cellular data network standards (e.g., 3G, 4G, LTE, etc.).

User input device 1486 may include any device (or devices) via which a user may provide signals to client computing system 1404; client computing system 1404 may interpret the signals as indicative of particular user requests or information. In various embodiments, user input device 1486 may include any or all of a keyboard, touch pad, touch screen, mouse or other pointing device, scroll wheel, click wheel, dial, button, switch, keypad, microphone, and so on.

User output device 1488 may include any device via which client computing system 1404 may provide information to a user. For example, user output device 1488 may include a display to display images generated by or delivered to client computing system 1404. The display may incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). Some embodiments may include a device such as a touchscreen that function as both input and output device. In some embodiments, other user output devices 1488 may be provided in addition to or instead of a display. Examples include indicator lights, speakers, tactile “display” devices, printers, and so on.

Some embodiments include electronic components, such as microprocessors, storage and memory that store computer program instructions in a computer readable storage medium. Many of the features described in this specification may be implemented as processes that are specified as a set of program instructions encoded on a computer readable storage medium. When these program instructions are executed by one or more processing units, they cause the processing unit(s) to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processing unit(s) 1412, 1414 and 1482 may provide various functionality for computing system 1402 and client computing system 1404, including any of the functionality described herein as being performed by a server or client, or other functionality associated with message management services.

It will be appreciated that computing system 1402 and client computing system 1404 are illustrative and that variations and modifications are possible. Computer systems used in connection with embodiments of the present invention may have other capabilities not specifically described here. Further, while computing system 1402 and client computing system 1404 are described with reference to particular blocks, it is to be understood that these blocks are defined for convenience of description and are not intended to imply a particular physical arrangement of component parts. For instance, different blocks may be but need not be located in the same facility, in the same server rack, or on the same motherboard. Further, the blocks need not correspond to physically distinct components. Blocks may be configured to perform various operations, e.g., by programming a processor or providing appropriate control circuitry, and various blocks might or might not be reconfigurable depending on how the initial configuration is obtained. Embodiments of the present invention may be realized in a variety of apparatus including electronic devices implemented using any combination of circuitry and software.

While the invention has been described with respect to specific embodiments, one skilled in the art will recognize that numerous modifications are possible. For instance, although specific processes are described with reference to FIGS. 8 and 9, other processes may be implemented. Embodiments of the invention may be realized using a variety of computer systems and communication technologies including but not limited to specific examples described herein.

Embodiments of the present invention may be realized using any combination of dedicated components and/or programmable processors and/or other programmable devices. The various processes described herein may be implemented on the same processor or different processors in any combination. Where components are described as being configured to perform certain operations, such configuration may be accomplished, e.g., by designing electronic circuits to perform the operation, by programming programmable electronic circuits (such as microprocessors) to perform the operation, or any combination thereof. Further, while the embodiments described above may make reference to specific hardware and software components, those skilled in the art will appreciate that different combinations of hardware and/or software components may also be used and that particular operations described as being implemented in hardware might also be implemented in software or vice versa.

Computer programs incorporating various features of the present invention may be encoded and stored on various computer readable storage media; suitable media include magnetic disk or tape, optical storage media such as compact disk (CD) or DVD (digital versatile disk), flash memory, and other non-transitory media. Computer readable media encoded with the program code may be packaged with a compatible electronic device, or the program code may be provided separately from electronic devices (e.g., via Internet download or as a separately packaged computer-readable storage medium).

Thus, although the invention has been described with respect to specific embodiments, it will be appreciated that the invention is intended to cover all modifications and equivalents within the scope of the following claims.

1. A method comprising:
receiving first electronic content having a first format, wherein the first format has a first style for displaying the first electronic content;
identifying, by a computer system, a plurality of attributes of semantic data in the first electronic content, wherein one or more of the plurality of attributes of the semantic data identify content items in the first electronic content;
extracting, by the computer system, from the first electronic content, the semantic data corresponding to the plurality of attributes;
receiving, by the computer system, via a graphical interface, first input by a user, the first input defining a specification for displaying the content items at a destination, wherein the specification includes an arrangement having a format and a layout for displaying the content items;
determining a display configuration of the destination;
selecting, based on the display configuration and the specification, a template from a plurality of templates for displaying the content items;
modifying the semantic data based on second input received via the graphical interface, wherein the second input includes data to modify a first attribute of the plurality of attributes of the semantic data;
generating, by the computer system, using the display configuration and the selected template, second electronic content to display the content items, the second electronic content including the content items and the modified semantic data, wherein the second electronic content is generated to have a second format, the second format having a second style for displaying the second electronic content according to the selected template; and
sending the generated second electronic content for display at the destination.

2. The method of claim 1, wherein identifying the plurality of attributes of the semantic data includes:
identifying style format data of the first format in the first electronic content, the style format data including one or more style attributes defining the first style; and
parsing, using the identified style format data, the first electronic content to identify each of the plurality of attributes.

3. (canceled)

4. The method of claim 1, wherein each of the plurality of templates defines a different editorial layout for displaying the content items.

5. (canceled)

6. (canceled)

7. (canceled)

8. The method of claim 1, wherein the plurality of attributes includes a title, a subtitle, an author, a body, and a set of images.

9. The method of claim 1, wherein the first format is a portable document format (PDF), wherein the second format is a hypertext markup language (HTML) format, and wherein the semantic data is in a semantic HTML format.

10. The method of claim 1, wherein the destination is a mobile device that displays the second electronic content in a Web application.

11. The method of claim 1, wherein the destination is a computing system that displays the second electronic content in a social media application.

12. The method of claim 1, wherein the template of the plurality of templates is created using one or more of hypertext markup language (HTML), cascade style sheets (CSS), or JavaScript.

13. A system comprising:
a semantic data store storing semantic data extracted from a plurality of different electronic content;
one or more processors; and
a memory accessible to the one or more processors, the memory storing instructions which, when executed by the one or more processors, causes the one or more processors to:
receive first electronic content having a first format, wherein the first format has a first style for displaying the first electronic content;
identify a plurality of attributes of semantic data in the first electronic content, wherein one or more of the plurality of attributes of the semantic data identify content items in the first electronic content;
extract, from the first electronic content, the semantic data corresponding to the plurality of attributes;
store the semantic data in the semantic data store;
receive, via a graphical interface, first input by a user, the first input defining a specification for displaying the content items at a destination, wherein the specification includes an arrangement having a format and a layout for displaying the content items;
determine a display configuration of the destination;
select, based on the display configuration and the specification, a template from a plurality of templates for displaying the content items;
modify the semantic data based on second input received via the graphical interface, wherein the second input includes data to modify a first attribute of the plurality of attributes of the semantic data;
generate, using the display configuration and the selected template, second electronic content to display the content items, the second electronic content including the content items and the modified semantic data, wherein the second electronic content is generated to have a second format, the second format having a second style for displaying the second electronic content according to the selected template; and
transmit the generated second electronic content for display at the destination.

14. The computer system of claim 13, wherein the instructions, when executed by the one or more processors, further causes the one or more processors to:
generate the graphical interface, wherein the graphical interface includes the content items and a plurality of interactive elements; and
wherein a first interactive element of the plurality of interactive elements receives the first input defining the specification for displaying the content items at the destination;
wherein a second interactive element of the plurality of interactive elements receives the second input including the data to modify the first attribute of the plurality of attributes of the semantic data.

15. A method comprising:
extracting, by a computer system, first semantic data from first electronic content having a first style format, wherein the first semantic data corresponds to a first plurality of attributes that define first content items in the first electronic content;
extracting, by the computer system, second semantic data from second electronic content having a second style format, wherein the second semantic data corresponds to a second plurality of attributes that define second content items in the second electronic content;
receiving, via a graphical interface provided by the computer system, first input indicating a request to display third content items, wherein the first input defines a specification for displaying the third content items and the request indicates a value of an attribute to identify the third content items, and wherein the specification includes an arrangement having a format and a layout for displaying the third content items;
identifying third semantic data associated with the attribute having the value indicated by the request, wherein the third semantic data is identified based in part on the first semantic data and the second semantic data, and wherein the third semantic data corresponds to a plurality of attributes that define the third content items;
determining a display configuration of a first destination of a plurality of destinations;
selecting, based on the display configuration and the specification, a template from a plurality of templates for displaying the third content items identified by the plurality of attributes that correspond to the third semantic data;
modifying the third semantic data based on second input received via the graphical interface, wherein the second input includes data to modify a first attribute of the plurality of attributes that correspond to the third semantic data;
generating, using the display configuration of the first destination and the selected template, third electronic content to display the third content items at the first destination, wherein the third electronic content includes the third content items and the modified third semantic data, and wherein the third electronic content is generated to have a third style format for displaying the third electronic content according to the selected template; and
sending the generated third electronic content for display at the first destination.

16. The method of claim 15, further comprising:
storing, to a semantic data store, the first semantic data in association with the first plurality of attributes;
storing, to the semantic data store, the second semantic data in association with the second plurality of attributes; and
wherein identifying the third semantic data includes searching the semantic data store for semantic data corresponding to an attribute having the value indicated by the request, and wherein the third semantic data includes the first semantic data and the second semantic data corresponding to the attribute.

17. The method of claim 15, wherein the first electronic content corresponds to a first editorial article and wherein the second electronic content corresponds to second editorial article that different from the first editorial article.

18. The method of claim 15, wherein the first style format, the second style format, and the third style format are different from each other.

19. The method of claim 15, wherein the value indicates a subject matter, and wherein the third semantic data is identified by searching the semantic data store for semantic data associated with one or more attributes matching the subject matter.

20. The method of claim 15, further comprising:
determining a display configuration of a second destination of the plurality of destinations, wherein the second destination is distinct from the first destination;
generating, using the display configuration of the second destination and the selected template, fourth electronic content to display the third content items at the second destination, wherein the fourth electronic content includes the third content items the modified semantic data, and wherein the fourth electronic content is generated to have a fourth style format for displaying the fourth electronic content according to the selected template; and
sending the generated fourth electronic content for display at the second destination.

21. The method of claim 1, wherein the arrangement includes one or more display attributes for displaying the content items.

22. The method of claim 1, further comprising:
receiving, via the graphical interface, third input to request a preview of the semantic data; and
generating an additional graphical interface to display the semantic data.

23. A method comprising:
receiving first electronic content having a first format, wherein the first format has a first style for displaying the first electronic content, and wherein the first format is a portable document format (PDF);
identifying, by a computer system, a plurality of attributes of semantic data in the first electronic content, wherein the semantic data is in a semantic hypertext markup language (HTML) format, wherein the plurality of attributes includes a title, a subtitle, an author, a body, and a set of images, wherein one or more of plurality of attributes of the semantic data identify content data in the first electronic content, and wherein identifying the plurality of attributes of the semantic data includes:
identifying style format data of the first format in the first electronic content, the style format data including one or more style attributes defining the first style; and
parsing, using the identified style format data, the first electronic content to identify each of the plurality of attributes;
extracting, by the computer system, from the first electronic content, the semantic data corresponding to the plurality of attributes;
receiving, by the computer system, a specification for displaying the content data at a destination;
determining a display configuration of the destination;
selecting, based on the display configuration and the specification, a template from a plurality of templates for displaying the content data, wherein the template of the plurality of templates is created using one or more of HTML, cascade style sheets (CSS), or Javascript;
receiving, via a graphical interface provided by the computer system, input including data to modify a first attribute of the plurality of attributes of the semantic data; and
modifying the semantic data based on the received input including the data to modify the first attribute;
generating, by the computer system, using the display configuration and the selected template, second electronic content to display the content data, the second electronic content including the content data and the modified semantic data, wherein the second electronic content is generated to have a second format, the second format having a second style for displaying the content data according to the selected template, and wherein the second format is an HTML format;
sending the generated second electronic content for display at the destination.

24. The method of claim 1, wherein the semantic data is in a semantic hypertext markup language (HTML) format, and wherein the plurality of attributes are identified by parsing the semantic data based on the semantic HTML format.

25. The system of claim 13, wherein the instructions, when executed by the one or more processors, further causes the one or more processors to:
receive, via the graphical interface, third input to request a preview of the semantic data; and
generate an additional graphical interface to display the semantic data.
